(19) United States
(12) Patent Application Publication
(10) Pub. No.: US 2026/0043892 A1
(43) Pub. Date: Feb. 12, 2026

(54) Methods and Systems of Tag Location Detection in an Inventory Environment based on Audio Attributes of Audio Signals Received from Tags using Audio Machine Learning

(71) Applicant: T-Mobile Innovations LLC, Overland Park, KS (US)

(72) Inventors: Lyle BERTZ, Lee’s Summit, MO (US); Robert BUTLER, Overland Park, KS (US); Rishi KHARE, Coppell, TX (US)

(21) Appl. No.: 18/799,882

(22) Filed: Aug. 9, 2024

(51) Int. Cl. G01S 5/18; G06K 19/06; G06Q 10/087; H04B 17/318

(52) U.S. Cl. CPC G01S 5/18; G06K 19/06037; G06Q 10/087; H04B 17/318

(57) ABSTRACT

A method comprises registering, by an application executing at a computer system in an inventory system, a tag identifier received from a tag in an inventory environment with location data indicating a location of the tag based on an audio attribute of an audio signal received from the tag, initiating, by the application, a scan of the tag to obtain tag data from the tag and to receive the audio signals from the tag by transmitting a signal to the tag after registering the tag identifier with the location data of the tag, and triggering, by the application, activation of an audio emitting device of the tag to emit an alert signal indicating whether a reader device is in a read range of the tag.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Modern inventory environments (e.g., warehouses and retail stores) may store items on behalf of various customers/business enterprises. Each item may be coupled to a tag, such as a Radio Frequency Identification (RFID) tag. Antenna systems and/or reader devices may be positioned throughout the inventory environment. RFID tags may include various components, such as, for example, an integrated circuit for storing and processing information, an antenna for communicating signals, etc. For example, the integrated circuit may include memory for storing tag data (e.g., a unique identifier), a modulator for modulating signals, and circuitry for power management. The RFID tag may receive signals from antenna systems/reader devices to obtain power, obtain power from the received signals, and transmit responses back to the reader devices.

### SUMMARY

In an embodiment, method for determining and managing locations of a plurality of tags in an inventory environment in which a physical obstruction is present in the inventory environment between a camera and a tag is disclosed. The method comprises receiving, by an application executing at a reader device in an inventory system, tag data from the tag in the inventory environment, in which the tag comprises a visual attribute and an audio emitting device configured to emit an audio signal having an audio attribute, the reader device is communicatively coupled to the camera and an audio detection device, and the camera is incapable of capturing an image depicting the visual attribute of the tag due to the physical obstruction. The method further comprises determining, by a system application executing at a management system in the inventory system, location data for the tag based on a received signal strength indicator (RSSI) of a signal received from the tag, in which the location data comprises three dimensional coordinates of each of the tags, storing, by the system application, the location data of the tag with the tag data received from the tag, receiving, by an audio application of an audio detection device in the inventory system, the audio signal having the audio attribute from the tag when the audio emitting device of the tag is activated to emit the audio signal, and identifying, by the system application, that the audio signal is received from the tag from which the tag data is received. The method further comprises determining, by the system application, audio-based location data of the tag based on the audio attribute of the audio signal received from the tag using a classification model system, and updating, by the system application, the location data of the tag to be the audio-based location data of the tag.

In another embodiment, an inventory system is disclosed. The inventory system includes one or more tags positioned in an inventory environment, a data store, a reader device comprising a first processor configured to execute a reader application, and an audio detection device positioned within an audio zone of the one or more tags and comprising a second processor configured to execute an audio application. The reader application is configured to initiate a scan of each the one or more tags, and receive tag data from each of the one or more tags. The audio application is configured to receive an audio signal from an audio emitting device of the one or more tags, obtain audio data associated with the audio signal and indicating an audio attribute of the audio signal, and determine, using a classification model system, location data for each of the one or more tags using the audio attribute of the audio signal received from each of the one or more tags based on a predefined schedule for individually scanning the one or more tags and pre-stored audio attributes of the one or more tags. The data store is configured to register locations of each of the one or more tags by storing the location data for each the one or more tags with the tag data received from each of the one or more tags based on the predefined schedule or the pre-stored audio attributes of the one or more tags.

In yet another embodiment, a method is disclosed. The method comprises registering, by an application executing at a computer system in an inventory system, a tag identifier received from a tag in an inventory environment with location data indicating a location of the tag based on an audio attribute of an audio signal received from the tag, initiating, by the application, a scan of the tag to obtain tag data from the tag and to receive the audio signals from the tag by transmitting a signal to the tag after registering the tag identifier with the location data of the tag, and triggering, by the application, activation of an audio emitting device of the tag to emit an alert signal indicating whether a reader device is in a read range of the tag, in which a second audio attribute of the alert signal indicates whether the reader device is in the read range of the tag, and the signal is used to activate the audio emitting device of the tag.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network including an inventory system with one or more reader devices, one or more cameras, one or more audio detection devices, and one or more tags with audio and visual attributes according to various embodiments of the disclosure.

FIGS. 2A and 2B is are diagrams illustrating exemplary processes for registering tags with audio attributes using the inventory system of FIG. 1 according to various embodiments of the disclosure.

FIGS. 3A and 3B are diagrams illustrating exemplary processes for updating location data describing a location of tags in the inventory system of FIG. 1 according to various embodiments of the disclosure.

FIG. 4 is a diagram illustrating alerts that may be provided using the tags with audio attributes in the inventory system of FIG. 1 according to various embodiments of the disclosure.

FIGS. 5A and 5B are diagrams illustrating the use of one or more audio detection devices to update location data describing a location of a tag in the inventory system of FIG. 1 according to various embodiments of the disclosure.

FIG. 6 is a diagram illustrating the use of one or more audio detection devices to detect a tag and identify a location of a tag in an inventory system of FIG. 1 according to various embodiments of the disclosure.

FIG. 7 is a flowchart illustrating a first method of optimizing the inventory system of FIG. 1 according to various embodiments of the disclosure.

FIG. 8 is a flowchart illustrating a second method of optimizing the inventory system of FIG. 1 using registered tags according to various embodiments of the disclosure.

FIG. 9 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, an RFID tag (sometimes referred to herein as simply a “tag”) is a small electronic device that stores data and communicates with antennas and reader devices via radio waves for identification and tracking purposes. Tags may be attached to different types of items, which may enter, pass through, be stored at, or exit different inventory environments. An inventory environment may refer to a location in which items may be stored or located at least temporarily. For example, an inventory environment may be a warehouse or a retail store. An operator of the inventory environment may deploy antennas and/or reader devices at various positions throughout the inventory environment, in a mobile or stationary manner.

Antennas (separate from or part of a reader device) may operate to emit signals (e.g., radio frequency signals) into a region including the items with the tags. The tags within a range of the emitted signals may receive the signals and use the energy from the signals to harvest power at the tag. The tag may then use the power to send data back to reader devices (e.g., in the case of a passive RFID tag without a power source). Once the tags have obtained power, the tags may send various types of data associated with the tag and/or an item coupled to the tag to a reader device. The reader device may receive the response data from the tags, and use the data for various purposes or forward the data to external entities.

However, in some cases it may be challenging to identify and distinguish between different tags in an inventory environment. For example, reader devices may receive data from multiple tags in a scanning area. However, the users and the reader devices may be unable to distinguish and identify the tags from which the data is received. This may be because the tags may have a white background, may be fixed to an item with white packaging, and/or may be positioned in the inventory environment against a white background.

To resolve this, tags may be enhanced to include additional components that may help users and reader devices identify the existence of tags in the inventory environment, to ensure that the reader devices scan tags accurately and efficiently. In some cases, tags may include visual components to aid in visually identifying the tags, such as, for example, quick response (QR) codes, light emitting diodes (LEDs), sensors, etc. For example, a tag may include the baseline chip (e.g., integrated circuit/antenna) structure as a package, and the package may be visually enhanced to include a QR code printed onto the package or a QR code embodied as multiple LEDs, in which the LEDs may be lit up/colored dynamically to create a pattern. As another example, a tag may include one or more LEDs, which may be preset or programmatically set to emit light at a defined brightness or color for a defined duration upon activation (e.g., upon receiving power). In some cases, the tag may include multiple different visual components (e.g., an LED and a QR code).

In another case, tags may include audio components to aid in audibly identifying the tags. For example, the tags may include or be coupled to a speaker that may be preconfigured or programmatically configured to emit audio signals (e.g., sounds or sound waves). Tags may be coupled to additional computer systems or power sources to provide additional power for emitting the audio signals if needed. Each of the tags may emit the same audio signal or different audio signals, depending on the configuration of the tags. In this way, tags have evolved to include different visual attributes (e.g., the LEDs and QR codes) and/or emit audio signals with specific audio attributes (e.g., volume, pitch, amplitude, duration, etc.). The visual attributes and audio attributes of the tags may in some cases only be triggered after receiving power from a reader device, and the power may enable the reader devices (e.g., reader devices including or coupled to cameras and/or microphones, etc.) to recognize the presence of tags in an inventory environment.

However, reader devices may still not be enabled to associate the different tags having different attributes with the tag data received from the circuit on the tag. For example, the reader device may not be enabled to correlate the data received from the tags with the audio signals and audio attributes received by a microphone of the inventory system from a speaker of the tag (i.e., a speaker coupled to or part of the tag). In addition, the reader device (or a server coupled to the reader device) may only be enabled to determine a location of the tags based on a received signal strength indicator (RSSI) measured using the signals received from the tags. RSSI-based location methods are not only based on complex computations that may require a heavy processing load at reader devices, but these methods also are largely inaccurate (e.g., the determined locations using RSSI-based location methods may have an error range of up to 2-4 feet). Therefore, the inventory systems that include reader devices, cameras, and microphones to identify and read data from tags with different types of attributes are inefficient since the data from the tags may not be correlated with the tags themselves, and ineffective for identifying an accurate location of the tags.

U.S. Pat. App. No. XX/XXX,XXX, entitled “Methods and Systems of Tag Location Detection in an Inventory Environment based on Visual Attributes of Tags using Computer Vision,” by Lyle Bertz, et. al., filed August X, 2024 (hereinafter referred to as the “Tag Location Detection Patent Application”) is hereby incorporated by reference in its entirety. The Tag Location Detection Patent Application describes enhanced inventory systems that are capable of determining more accurate locations of different tags in an inventory environment using cameras, and associating the more accurate locations of the tags with tag data received from the tags using various methods of image-based analyses.

However, in some cases, inventory systems (e.g., reader devices communicatively coupled to or including cameras and microphones) may not always be in the field of vision of a tag when a tag needs to be read. For example, the user of the reader device may be searching an area for a particular tag in the inventory environment, but there may be a box, shelf, storage compartment or other obstruction physically blocking a field of view from the camera to the tag. In this case, the cameras may not be capable of identifying the visual attributes of the tag for tag detection and location determination due to the physical obstruction. Therefore, in some cases, image-based tag detection and analysis may be ineffective since tags are often positioned in boxes, crates, racks, etc., in which the tag itself may often be hidden or not-visible, buried deep within an area of multiple other tags.

The present disclosure addresses the foregoing technical problems by providing a technical solution in the technical field of inventory tracking, control, and management, by enhancing the ability of inventory systems to correlate the data received from the tags with a visual and/or audio attribute of the tag, and to leverage location data provided by cameras and/or microphones to provide a more accurate location of different tags in an inventory environment. In some embodiments, the reader devices in the inventory environment may include or be coupled to a one or more microphones (also referred to herein as “audio detection devices”) that may receive audio signals from the speakers of the tags. The audio signals may be used to measure a distance between the microphone and the speakers of the tags and determine or refine a location of the tags based on a classification model system trained to analyze and predict data using audio signals. An application either at the reader device or a management system in the inventory system may associate tag data received from the tags with the location data of the tags using the audio attributes of audio signals received from the tags. The location data and audio attributes may also be used to refine the RSSI-based location data of other tags that may not have audio or visual attributes, as further described herein. Therefore, the embodiments disclosed herein enable a more resource efficient method for accurately identifying a location of the tags in an inventory environment, even when the tags do not necessarily include visual attributes used for image-based location determination or audio attributes used for audio-based location determination.

In some embodiments, an inventory system may include one or more reader devices (e.g., stationary or mobile), antennas (e.g., separate from the reader devices or integrated with the reader devices), cameras and/or microphones (e.g., separate from the reader devices or integrated with the reader devices), tags (e.g., RFID tags that may or may not include additional visual and/or audio attributes), and a tag management system. The inventory environment (e.g., warehouse, retail store) may include the reader devices, cameras, microphones, antennas, and tags, in which the tags may be positioned on racks, pallets, conveyor belts, bins, etc., in the inventory environment. The tag management system may be provisioned on a computer system within the inventory environment or external to the inventory environment, in which the reader devices, cameras, and/or microphones may communicate with the tag management system over a network.

The inventory system may register each of the tags having audio attributes in the inventory environment, to maintain data describing the audio attributes of audio signals emanating from each of the respective tags and a most recent location of the tags. In an embodiment, each of the tags with audio attributes may be registered individually, one-by-one, according to a predefined schedule. In this embodiment, reader devices and/or microphones may be programmed with the predefined schedule, which may prescribe time intervals, time points, or a frequency during which to individually determine an audio-based location of individual tags and receive tag data from the individual tags.

For example, suppose an area of the inventory environment includes a rack with six different storage bins, in which each bin has a fixed tag with a speaker configured to emanate a particular audio signal in response to receiving an interrogation signal from a reader device. Thus, the area includes six fixed tags each having a similarly configured speaker, which may emanate the same audio signal or different audio signals. Each bin may also include multiple items affixed to corresponding lightweight tags that may not have any audio or visual attributes that may aid in location detection. The antenna/reader device may sequentially activate the speakers of each of the fixed tags individually, or one-by-one, by transmitting a signal to the tag according to a time indicated in the predefined schedule. The tag may use the power obtained from the signal to activate the speaker (e.g., emanate an audio signal with sound waves) according to a preconfigured instruction indicating an audio attribute of the audio signal to be emitted by the speaker. The audio attribute may be, for example, a volume of the audio signal, a pitch of the audio signal, a frequency of the audio signal (e.g., 20 Hz to 20 kHz frequencies, lower ultrasound frequencies, and higher frequencies), an amplitude of the audio signal, a tone of the audio signal, a particular predefined harmonic audio signal, etc. The microphone may then receive the audio signal with the audio attribute from the activated speaker of the tag to detect the presence of the tag according to the time indicated in the predefined schedule.

The microphone may capture the audio signal from the speaker of the tag (e.g., the sound waves emitted by the speaker of the tag) and obtain audio data corresponding to the audio signal received from the tag. For example, the microphone may capture a recording of the audio signal, and use the recording as the audio data corresponding to the audio signal received from the tag. As another example, the microphone may convert the audio signal into electrical signals that are digitized into the audio data (e.g., in a waveform or a digital audio file) corresponding to the audio signal received from the tag. The audio data may indicate the audio attributes of the audio signal (e.g., the audio data may indicate the sound, amplitude, frequency, volume, pitch, tone, etc., of the audio signal received from a speaker).

The microphone may transmit the audio data to an application at the inventory system (e.g., the server application at the management server or an application at the reader device). The application may first identify the audio signal as one that is associated with a tag (i.e., as opposed to other types of audio signals received from tasks performed at the inventory environment, movement of items in the inventory environment, humans speaking to one another, music playing in the inventory environment, etc.), and then determine a distance from the microphone to the tag and/or a location of the tag based on the audio attribute of the audio signal. The server application may perform the aforenoted identification and determination steps using a classification model system, which may be trained based on labelled audio signals that identify different types of audio signals coming from tags and trained based on labeled distances/locations based on the audio signals. The reader device, microphone, and management system may perform these steps individually for each of the six fixed tags, until the inventory system has data describing the audio attributes of each of the fixed tags, the tag data received from each of the tags, and a most recent location of each of the fixed tags.

In another embodiment, multiple tags with audio attributes in an area may be registered together based on pre-stored data describing the audio attributes on different tags and the corresponding tag data for the different tags. In this embodiment, the reader device and microphone may not need to individually scan each tag and determine the distance to the activated speaker of the tag according to a pre-defined schedule. Instead, the reader device and/or management server may be programmed to correlate the identified audio attributes (e.g., the volume, pitch, duration, amplitude, frequency, etc., of each audio signal) received from the tags and received tag data with pre-stored audio attributes of different tags. The pre-stored audio attributes of different tags may be previously provided to the management system (e.g., in the form of recordings of the audio signals, a digital audio file of the audio signals, or data describing the audio attributes of the audio signals), and the management system may store the received audio attributes with tag data received from the tags. For example, the data store may have entries indicating that a tag identifier 1A of a first tag has a speaker that emits a first audio signal with a preprogrammed frequency when activated, a tag identifier 1B of a second tag has a speaker that emits a second audio signal with a preprogrammed volume when activated, a tag identifier 1C of a third tag has a speaker that emits a third audio signal for a preprogrammed, unique duration when activated, etc. In this embodiment, each of the audio signals received from each of the different speakers/tags may be different from one another, to ensure that the audio signals can be correlated back to specific tags based on the unique audio attributes of the audio signal.

In this embodiment, the reader device may transmit signals to all six fixed tags to simultaneously activate the speakers on all six fixed tags and receive tag data from each of the six fixed tags. The microphone may then receive the audio signals from the six activated speakers on all six fixed tags. The microphone may obtain audio data for each of the audio signals, and transmit the audio data to an application in the inventory system (e.g., the application at the reader device and/or the system application at the management system). For example, the microphone may receive a continuous stream of audio signals from an area in the inventory environment including the six fixed tags, other items/tags, and other users performing tasks in the area and moving items within the area, into the area, and out of the area. The microphone may obtain audio data based on the continuous stream of audio signals and transmit the audio data to the application at the management server or the reader device.

The application may use the classification model system to first separate out the different individual audio signals based on the received audio data, and identify the audio signals that may be received from speakers on tags, as opposed to other sounds and signals that may be detected and recorded in the area. To this end, the classification model system may be trained based on labeled audio signals that are known to be associated with speakers on tags, such that classification model system may be used to accurately identify audio signals that arrive from speakers on tags. The application may then use the classification model system to determine a location of each of the tags based on the audio data describing the audio signals received from each of the tags. To this end, the classification model system may be trained based on labeled audio signals that are known to be at certain locations or certain distances from the microphone, such that the classification model system may be used to accurately predict a location of the tags based on the audio attributes of the tags. At this stage, the application has obtained a predicted audio-based location for each of the tags, and the reader device has separately received the tag data from each of the tags.

Next, the application may compare the audio data describing the audio attributes of each the six activated speakers on the six fixed tags with pre-stored audio attributes to identify a match between a currently captured audio attribute and a pre-stored audio attribute, and thus to obtain a corresponding tag identifier of the currently captured audio attribute. For example, the application may determine that a volume of an audio signal received from a speaker on a first tag matches a stored audio attribute of a tag having a tag identifier of 1, the application may determine that a pitch of an audio signal received from a speaker on a second tag matches a stored audio attribute of a tag having a tag identifier of 2, the application may determine that a tone of an audio signal received from a speaker on a third tag matches a stored audio attribute of a tag having a tag identifier of 3, etc. The application may similarly identify matches for each of the six audio signals to obtain a corresponding tag identifier for each of the six fixed tags. The application may then store the determined location of each speaker/tag with the tag identifier of each of the six fixed tags as location data for each of the six fixed tags to complete registration of the tags.

Therefore, in both of the aforementioned embodiments, an initial registration for each of the tags with the audio attributes of the tags may be performed to store data describing the audio attributes of each tag, with tag data (e.g., a tag identifier) of each tag, and with the most recent location data of each tag. The most recent location data stored at registration may be an audio-based location of the tag, which may be determined using an audio signal received from a speaker of the tag, as described above. The audio-based location of the tag may be far more accurate than an RSSI-based location of the tag. Nevertheless, the application may additionally calculate the RSSI-based location of not only the six fixed tags in the area, but also calculate the RSSI-based location of all of the lightweight tags (e.g., tags without visual attributes) in each of the six bins. For example, the reader device may determine the location data for all of the lightweight tag using an RSSI-based location method based on a signal strength of the received signal carrying the tag data from each of the lightweight tags.

However, as mentioned above, the RSSI-based locations of the tags are largely inaccurate (e.g., sometimes having an error of up to several feet). Therefore, the application may refine the location data of the tags in the inventory environment when audio-based location data may be available and relevant to the tags. For example, in the situation described above, there are multiple lightweight tags without audio (or visual) attributes within each of the six bins, and RSSI-based location data may be stored in the data store for each of the lightweight tags. However, each of the six bins may also be associated with audio-based location data of the six fixed tags according to the aforementioned registration process of each of the six fixed tags with speaker. The audio-based location data may refer to the determined distance between a microphone and the speaker on the tag, and/or a determined location of the speaker on the tag (which may use data received from three different speakers and may be based on triangulation methods). In this case, the data store may include location data for all of the tags (the six fixed tags with speakers being associated with audio-based location data and the lightweight tags being associated with RSSI-based location data).

The system may maintain one or more rules for refining the RSSI-based location data to use more accurate audio-based location data. A rule may define various location areas or three-dimension bounding boxes (e.g., each of the bins may correspond to a location area), such that when RSSI-based location data and audio-based location data is included in the same location area, then the RSSI-based location data may be updated to be the audio-based location data. The application may determine, according to the rule, that the location data for at least a subset of the identified lightweight tags (i.e., the RSSI-based location) may be refined or updated based on the location data for one of the fixed tags. In this way, the data store may reflect that all the lightweight tags inside each bin has the same location data as the fixed tag on each respective bin.

In some embodiments, the response from a tag with an audio attribute may be recalibrated to ensure optimal performance and accurate detection. For example, the microphone may capture an audio signal from each speaker on each tag periodically and update the registration to reflect any changes to the audio attributes of each of the audio signal. The reader device may also scan the tag to retrieve a signal back from the tag with the tag data, and the reader device may record the signal strength, read range, and any other issues (e.g., missed reads or inconsistent data). The recalibrated audio data and/or signal may be used to update the data stored at the data store in association with each tag, to ensure that tags may be read accurately and the location data for the tags have been updated accurately.

In some embodiments, the reader device may trigger the audio attributes of the tags to be dynamically updated based on various factors to provide alerts for users. For example, an audio signal emitted by a speaker of a tag may be dynamically set in response to a scan by the reader device based on a distance between the reader device and the tag. The dynamic setting of the speaker may indicate different types of data to the user of the reader device (e.g., whether the reader device is in the optimal read range of the tag or outside the optimal read range of the tag, whether the reader device is transmitting sufficient or insufficient power to the tag, etc.). For example, suppose an optimal read range from a tag is between 100 centimeters (cm) and 400 cm from the tag. As the user approaches the tag with the reader device, the reader device may simultaneously and continuously transmit signals to the tag and trigger a microphone to capture an audio signal emitted by the speaker of the tag. The audio signal may be converted to audio data and used to identify a distance between the microphone and the speaker. The reader device may then transmit a signal (e.g., radio frequency signal) with instructions based on a particular audio attribute to the tag. Upon receiving the signal, the speaker may be programmed to activate or emit audio signals with specific audio attribute indicated in the instruction based on a distance between the microphone and the speaker (e.g., the speaker may emit audio signals at a high pitch when the distance between the microphone and the speaker is between 50 cm-100 cm, emit audio signals at a medium pitch when the distance between the microphone and the speaker is between 100 cm-400 cm, and emit audio signals at a low pitch when the distance between the microphone and the speaker is greater than 400 cm). In this way, the user may listen to the pitches of the audio signals emanating from the tags to determine whether the reader device is in the optimal read range of a tag to-be detected.

In an embodiment, the reader device may be coupled to or include both a camera and a microphone. Meanwhile, one or more tags in an area of the inventory environment may be coupled to or include both visual attributes (e.g., LEDs/QR codes) and audio attributes (e.g., speakers emanating audio signals). In this embodiment, the inventory system is enhanced to perform both image-based location methods, as described in the Tag Location Detection Patent Application, and to perform the audio-based location methods disclosed herein. This may be particularly helpful in embodiments in which there are physical obstructions between the camera/reader device and the tags with visual attributes. In this case, the physical obstruction may prevent the camera from being able to capture an image depicting the visual attributes of the tag. However, audio signals emanating from the tag may still be audibly detectable, and thus captured and analyzed as described herein, to identify the tag and determine an audio-based location of the tag, which may be still more accurate than an RSSI-based location of the tag.

Accordingly, the embodiments disclosed herein enable tag data received from different tags to be correlated with audio-based location data determined using an audio attribute detectable on the tags. Inventory systems may thus maintain far more accurate location data of the tags using audio-based location data, as opposed to RSSI-based location data. The system described herein can be used to receive inventory items into an inventory environment and to monitor the location and re-location of the inventory items within the inventory environment. The system can be used to locate inventory items that are required for picking and dispatching to complete a fulfillment order. The system can be used to tally up totals of different categories or models of inventory that are currently in stock.

The embodiments disclosed herein also enable a method whereby nearby lightweight tags that do not include distinguishable attributes may rely on the more accurate audio-based location data than the RSSI-based location data. Therefore, the embodiments disclosed herein enable a more efficient use of the resources in the inventory system using more accurate locations of the task, thereby increasing inventory system efficiency and capacity.

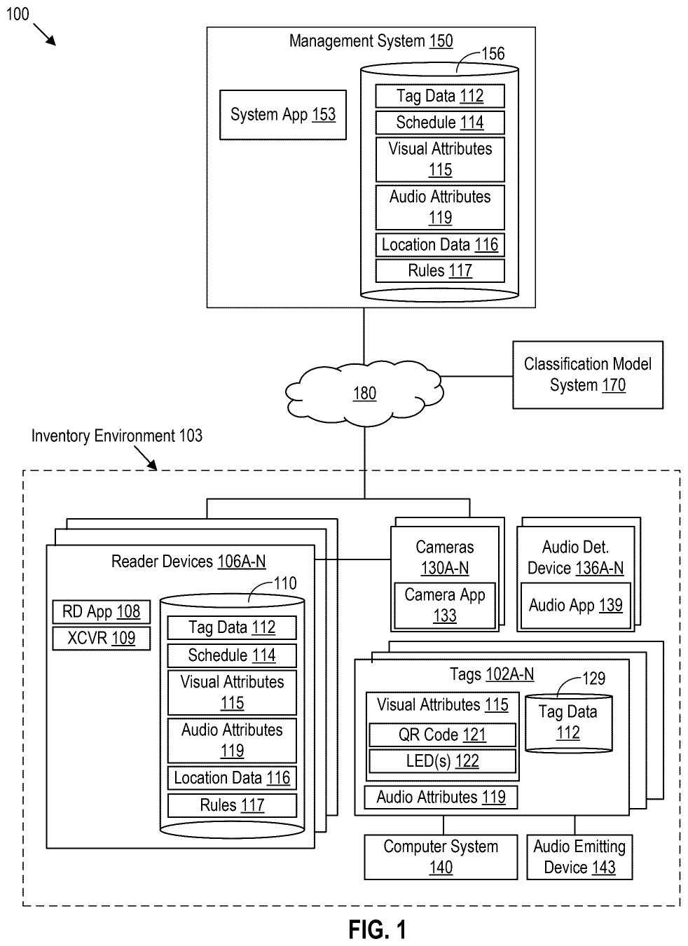

Turning now to FIG. 1, a communication network 100 is described. The communication network 100 includes an inventory environment 103, a management system 150, a classification model system 170, and a network 180. The inventory environment 103 includes one or more tags 102A-N, one or more reader devices 106A-N, one or more cameras 130A-N, and one or more audio detection devices 136A-N. The network 180 may be one or more private networks, one or more public networks, or a combination thereof. While the management system 150 is shown in FIG. 1 as being separate from network 180, in some embodiments, it should be appreciated that the management system 150 may be part of the network 180. In the embodiment shown in FIG. 1, an inventory system may include the management system 150, the reader devices 106A-N, cameras 130A-N, audio detection devices 136A-N, and tags 102A-N.

The tags 102A-N may each be small devices used in inventory systems to store and transmit data wirelessly to reader devices 106A-N. Tags 102A-N may be coupled to (e.g., affixed to) different items and thus may be used for tracking and identifying the items, enabling efficient inventory management and asset tracking in various inventory environments 103 (e.g., warehouses, retail stores, centers, etc.). Each tag 102A-N includes a microchip (e.g., an integrated circuit with processing and memory resources) for data storage and processing and an antenna for communication. The microchip of the tags 102A-N may include a data store 129 (e.g., one or more memories), which may store tag data 112 associated with the tag 102A-N. The tag data 112 may include a variety of data, such as, for example, a tag identifier (e.g., a unique serial number or electronic product code (EPC) distinguishing different tags 102A-N from one another), item information (e.g., data about the item to which the tag 102A-N is attached), manufacturer or supplier information about the item, logistics data, usage data (e.g., records and when and where the tag 102A-N has been scanned), etc.

One or more of the tags 102A-N may include visual attributes 115 used for visual sensing by a camera 130A-N, in which the visual attributes 115 may include, for example, one or more QR codes 121 and/or LEDs 122. The visual attributes 115 may also include different color schemes, patterns (e.g., of LEDs 122 or colors), and/or other visual markers that may be used for object identification using a camera 130A-N. In some cases, the LEDs 122 may be arranged on a tag 102A-N to embody a QR code 121 when lit-up. The visual attributes 115 on the tags 102A-N may include, for example, one or more QR codes 121, LEDs 122, LEDs 122 that are lit according to a predefined pattern (e.g., a multi-LED pattern configuration lit according to a pattern (e.g., QR code 121)), polka dotted patterns, striped patterns, different color schemes, patterns (e.g., of LEDs 122 or colors), and/or other visual markers with a known size and/or shape that may be used for object identification using a camera 130A-N. In some cases, the LEDs 122 may be arranged on a tag 102A-N to embody a QR code 121 when lit-up.

One or more of the tags 102A-N may also include audio attributes 119 based on the audio signals emitted from audio emitting devices 143 coupled to or included as part of the tags 102A-N. For example, the audio emitting device 143 may refer to a speaker, coupled to or part of the tag 102A-N, which may be powered using signals received from a reader device 106A-N and/or using the computer system 140 (which may include an additional power source for powering the audio emitting device 143). The audio emitting device 143 may emit audio signals having the audio attributes 119. The audio attributes 119 may refer to various features or attributes of the audio signals emitted from the audio emitting device 143, and may include, for example, a volume, pitch, tone, frequency, amplitude, duration, etc., of the audio signals emitted from the audio emitted device 143. The frequency of an audio signal may be between 20 Hz and 20 kHz, but may in some cases encompass lower ultrasound frequencies and/or higher frequencies (e.g., 25 kHz). For example, a tag 102A-N may include a multi-speaker arrangement (multiple audio emitting devices 143), which may output a combination of audio signals used to firm an audio signature that may have specific audio attributes 119, discernable by the system using the classification model system 170.

The reader devices 106A-N may be electronic devices or computer systems configured to transmit signals to the tags 102A-N to both power the tags 102A-N and trigger the tags 102A-N to respond to the signal with at least a portion of the tag data 112 stored on the tag 102A-N. Each of the reader devices 106A-N include an application 108 and a radio transceiver 109 (shown as “XCVR 118” in FIG. 1). The application 108 may be instructions stored on a memory of the reader device 106A-N, which may be executed by a processor of the reader device 106A-N to scan the tags 102A-N, trigger the cameras 130A-N, trigger the audio detection devices 136A-N, and communicate tag data 112 and other data upstream to the management system 150. The radio transceiver 109 may include radio equipment enabling the reader devices 106A-N to communicate with other devices in the inventory environment 103 and/or to the management system 150 over the network 180.

The reader devices 106A-N may also include a data store 110 (e.g., one or more memories) for storing tag data 112, schedules 114, visual attributes 115, audio attributes 119, location data 116, and rules 117. The schedules 114 may indicate predefined time intervals or time points for a reader device 106A-N to initiate scanning one or more tags 102A-N, capture an image depicting visual attributes 115 of the one or more tags 102A-N, and/or obtain audio signals indicating the audio attributes 119 of the one or more tags 102A-N.

The tag data 112 may be received from the different tags 102A-N in the inventory environment 103. For example, the tag data 112 may include the tag identifier received from the tags 102A-N. The visual attributes 115 may describe the visual features/markers on each of the tags 102A-N in the inventory environment 103 that may be used by a camera 130A-N as a point for object detection and location determination. For example, the visual attributes 115 may indicate whether the tag 102A-N includes an LED 122 or a QR code 121, and/or where the LED(s) 122 or QR code(s) 121 are positioned on the tag 102A-N. The visual attributes 115 may indicate a quantity and/or pattern of LEDs 122 on the tag 102A-N, a color of each LED 122 on the tag 102, a brightness level of each LED 122 on the tag 102A-N, etc. The visual attributes 115 may indicate the pattern of the QR code 121 on the tag 102A-N, a position of the QR code 121 on the tag 102A-N, a color of the printed QR code 121 on the tag 102A-N, whether the QR code 121 is printed on the tag 102A-N in ink or embodied as a pattern of LEDs 122, etc. The visual attributes 115 may indicate a background color of the tag 102A-N, a border color of the tag 102A-N, one or more features of a visual mark on the tag 102A-N, etc. The visual attributes 115 may be stored at the data store 110 and/or data store 156 at the management system 150 prior to registration of the tags 102A-N or after registration of the tags 102A-N. When the visual attributes 115 are stored after registration of the tags 102A-N, the visual attributes 115 may indicate the visual attributes 115 of each tag 102A-N that are captured in an image by the camera 130A-N during registration. When the visual attributes 115 are stored prior to registration of the tags 102A-N, the visual attributes 115 may indicate the visual attributes 115 of each tag 102A-N, which may be manually entered by an operator, or previously captured by a prior image of the tag 102A-N.

The audio attributes 119 may describe the features or characteristics of audio signals received from the audio emitting device 143 on each of the tags 102A-N in the inventory environment 103. The audio attributes 119 may be used for tag 102A-N detection and location determination, in some cases, using the classification model system 170. For example, the audio attributes 119 may indicate whether the tag 102A-N includes an audio emitting device 143 (e.g., speaker). The features or characteristics of the audio signal described in the audio attributes 119 may also include, for example, a volume of the audio signal (e.g., a perceived loudness or softness of the sound—may be related to the amplitude of the sound wave), a pitch of the audio signal (e.g., a perceived frequency of the sound—may be related to the frequency of the sound wave), a tone of the audio signal (e.g., a perceived quality or color of the sound, influenced by the harmonic content of the sound), a duration of the audio signal (e.g., a length of time that the sound is detected by the audio detection device 136A-N), an amplitude of a sound wave of the audio signal (e.g., indicating a power of the sound), a frequency of the sound wave (e.g., a number of oscillations of the sound wave), a reverberation of the audio signal (e.g., a persistence of the sound in space after the audio signal is emitted), an echo of the audio signal (e.g., a distinct reflection of the sound that arrives at the audio detection device 136A-N), harmonics of the audio signal (e.g., frequencies of the audio signal that are multiples of the fundamental frequency), etc.

The audio attributes 119 may be stored at the data store 110 and/or data store 156 at the management system 150 prior to registration of the tags 102A-N or after registration of the tags 102A-N. When the audio attributes 119 are stored after registration of the tags 102A-N, the audio attributes 119 may indicate the audio attributes 119 (e.g., the characteristics and features) of each audio signal received from each tag 102A-N during registration. When the audio attributes 119 are stored prior to registration of the tags 102A-N, the audio attributes 119 may indicate the audio attributes 119 of audio signal that may be received from each tag 102A-N, which may be manually entered by an operator, or previously captured by an audio detection device 136A-N. The location data 116 may include 3D coordinates or a general location range of the tags 102A-N. The location data 116 may be categorized as either RSSI-based location data, image-based location data, or audio-based location data. RSSI-based location data may be determined for lightweight tags 102A-N that do not have distinguishable visual attributes 115 or audio attributes 119, and thus the reader device 106A-N (or management system 150) may have determined a location of these lightweight tags 102A-N based on a signal strength of the signal received from the lightweight tags 102A-N. Image-based location data 116 may be determined for tags 102A-N that have visual attributes 115, and thus the camera 130A-N and the reader device 106A-N may determine a location of these tags 102A-N based on an image depicting the visual attributes 115 of the tags 102A-N. Audio-based location data may be determined for tags 102A-N that have audio attributes 119, and thus the audio detection device 136A-N and the reader device 106A-N may determine a location of these tags 102A-N based on the audio attributes 119 describing the audio signals received from the tags 102A-N.

In an embodiment, the data store 110 may include records or entries for each identified tag 102A-N in the inventory environment 103. A record for a tag 102A-N may include the corresponding tag data 112 received from the tag 102A-N, the visual attributes 115 on the tag 102A-N (if any), the audio attributes 119 of audio signals emitted from the tag 102A-N (if any), the location data 116 of the tag 102A-N (e.g., RSSI-based, image-based, or audio-based), and any other data associated with the tag 102A-N. In some cases, the location data 116 may indicate a most recently determined location of the tag 102A-N and prior locations of the tag 102A-N as the tag 102A-N moves through the inventory environment 103, and may indicate a timestamp or duration of the tag 102A-N being in the prior location.

The rules 117 may include location grouping rules (e.g., logic, code, conditions, etc.), which may be used by the application 108 at the reader device 106A-N (or the system application 153 at the management system 150) to determine whether and how to update location data 116 for a tag 102A-N. For example, the rules 117 may define location areas or 3D bounding boxes, in which location data 116 for a tag 102A-N is to be updated (e.g., from an RSSI-based location to an image-based location or audio-based location). The image-based location may be given a higher priority than the audio-based location if both are available for a tag 102A-N since the image-based location may be more accurate than the audio-based location, particularly when the image-based location is obtained using an image captured by a depth camera 130A-N.

The cameras 130A-N may be integrated into the reader devices 106A-N, or may be standalone separate devices that may be communicatively coupled to the reader devices 106A-N. In an embodiment, each of the cameras 130A-N may be depth cameras, which are imaging devices that capture 3D information about a distance between the camera 130A-N and an object in a field of view (e.g., a visual attribute 115 on a tag 102A-N). In this case, the cameras 130A-N may include a camera application 133, which may be instructions stored on a memory of the camera 130A-N and executable by a processor of the camera 130A-N.

The camera application 133 may capture images depicting one or more tags 102A-N in an inventory environment 103 and, in an embodiment, may determine distances between the camera 130A-N and the visual attributes 115 on the tags 102-N captured by the camera 130A-N. The cameras 130A-N may also include various depth imaging equipment, such as, for example, an infrared projector, an infrared sensor, a standard red green blue (RGB) camera, etc. For example, the cameras 130A-N may capture images in which each pixel contains depth information, representing the distance from the camera 130A-N to the object at the point, or representing a location of the object in space (e.g., as 3D coordinates). The image captured by a camera 130A-N may in some cases be a depth map or a 3D image, with distances reflected for each pixel. The camera application 133 may transmit captured images (e.g., as a continuous feed) to the management system 150, for tag detection, distance/location computation, and data storage.

In another embodiment, cameras 130A-N may be standard cameras for capturing, storing, and transmitting images, but the cameras 130A-N may not have depth calculation capabilities (e.g., may not be capable of calculating a distance from the camera 130A-N to each pixel captured in the image). In this case, the cameras 130A-N may transmit the images (e.g., as a continuous feed) to the management system 150. The system application 153 at the management system 150 may use a trained AI model (e.g., the classification model system 170 further described below) to determine a distance between the camera 130A-N and the identified tag 102A-N and/or determine a location of the identified tag 102A-N (as opposed to relying on depth computation capabilities of cameras 130A-N).

In an embodiment, an intensity or appearance of the LED(s) 122 (e.g., visual attributes 115) on a tag 102A-N may aid the camera application 133 in determining the distance from the camera 130A-N to the tag 102A-N (in some cases, using a computer vision method at the classification model system 170). In an embodiment, the camera application 133 (in some cases, and/or the application 108 and/or the system application 153) may estimate the power received/harvested at the tag 102A-N based on an appearance of the LED(s) 122 on the tag 102A-N (e.g., brightness, color, arrangement etc.). For example, an LED 122 that is emitting light at a decreased power level (relative to prior versions of the activated LED 122), the application 108 may determine that the power harvested by the tag 102A-N may be less than prior activations of the tag 102A-N. In one embodiment, the tag 102A-N may be programmed to use the harvested power to activate the LED(s) 122 using the power, or the tag 102A-N to be programmed to activate the LED(s) 122 according to a certain parameter (e.g., brightness level, specific color, arrangement, etc.) based on the power harvested at the tag 102A-N. That is, the tag 102A-N may either use the harvested power to activate the LEDs 122 (as bright as possible in a predefined color scheme or based on a predefined pattern), or the tag 102A-N may evaluate the harvested power to programmatically signal RSSI information using the LED(s) 122 to the reader device 106A-N. In this way, the cameras 130A-N may capture an image depicting the LED(s) 122 activated according to the specified parameter, and evaluate the LED(s) 122 to determine the RSSI intensity at the tag 102A-N. As described herein, the RSSI may be used to determine a location of the tag 102A-N. The camera application 133, application 108 at the reader device 106A-N, and/or the system application 153 at the management system 150 may store the evaluated parameters of the LED(s) 122, determined RSSI intensity, and RSSI-based location of the tag 102A-N in the data stores 110 and/or 156. In an embodiment, the visual attribute 115 of LEDs 122 on a tag 102A-N may be a grid of LEDs, and based on the signal received to power the tag 102A-N, the tag 102A-N may be programmed to illuminate the arrangement of LEDs 122 to display a pattern (e.g., a particular QR code 121).

In an embodiment, the camera application 133 may identify an orientation of the tag 102A-N and/or identify a particular tag 102A-N in a cluster of tags 102A-N based on the visual attribute 115. In some cases, the tags 102A-N may include multiple visual attributes 115 (e.g., an LED 122 and a QR code 121), and the camera application 133 may rely on the QR code 121 for detection when the LED 122 is not lighting up or is not sufficiently bright.

The audio detection devices 136A-N may be integrated into the reader devices 106A-N, or may be standalone separate devices that may be communicatively coupled to the reader devices 106A-N. In an embodiment, each of the audio detection devices 136A-N may be microphones or other devices with audio sensors that may capture audio signals (e.g., sound waves) and obtain audio data either in the form of a recording of the audio signals or in the form of converted electric signals. For example, the audio detection devices 136A-N may include standard microphones, microphone arrays, spatial audio capture devices, ultrasonic sensors, etc. In this case, the audio detection devices 136A-N may include an audio application 139, which may be instructions stored on a memory of the audio detection device 136A-N and executable by a processor of the audio detection device 136A-N.

The audio application 139 may capture or detect the audio signals received from a tag 102A-N or area in the inventory environment 103. The audio application 139 may then obtain audio data based on the audio signals by, for example, converting the sound waves of the audio signal into a recording of the audio signal or digital audio data that represents the original sound wave of the audio signal. The audio data may indicate the audio attributes 119 of the original audio signal, and the audio data may be further processed to extract specific audio features for analysis or playback. The audio application 139 may transmit the audio data indicating the audio attributes 119 of the audio signals to the application 108 at the reader devices 106A-N and/or the system application 153 at the management system 150 for further processing.

The management system 150 may be a device, UE, computer, or computer system, with various types of resources that may be interworked to control the operations of the reader devices 106A-N, cameras 130A-N, and audio detection devices 136A-N to maintain accurate data regarding tags 102A-N in the inventory environment 103. The management system 150 may include a processor, a memory, a radio transceiver, and other hardware or software components depending on the type of computer system running the management system 150. The management system 150 may include a system application 153, which may include instructions stored on a memory of the management system 150 and executable by a processor of the management system 150. The system application 153 may communicate with the reader devices 106A-N, cameras 130A-N, audio detection devices 136A-N, and classification model system 170, as further disclosed herein.

For example, system application 153 may programmatically generate the schedules 114 for reader devices 106A-N to execute when registering the tags 102A-N, or receive the schedules 114 from an operator. Similarly, the system application 153 may programmatically generate the rules 117, or receive the rules 117 from the operator. The system application 153 may push the schedules 114 and rules 117 to one or more reader devices 106A-N in the inventory environment 103 over the network 180.

The system application 153 may receive tag data 112 associated with different tags 102A-N from the reader devices 106A-N, and may determine the location data 116 for the tags 102A-N based on the tag data 112 (e.g., the RSSI-based location data). When the camera 130A-N is a depth camera capable of computing depth at various visual markers in an image, the camera 130A-N may transmit (a stream of) captured images with depth data for each pixel in each captured image to the system application 153 over the network 180. The system application 153 may identify the different tags 102A-N in the image based on the visual attributes 115 detected in the image, in some cases, using the classification model system 170, which as further described below may be trained to facilitate identification of tags 102A-N with or without visual attributes 115 in the image. The system application 153 may then determine the actual location data 116 (e.g., x, y, z coordinates) for each tag 102A-N captured in the image based on the depth data (e.g., the distance from the camera 130 to the identified tags 102A-N).

In contrast, when the camera 130A-N is not a depth camera, the camera 130A-N may transmit captured images (without depth data) to the system application 153 over the network 180. Again, the system application 153 may identify the different tags 102A-N in the image based on the visual attributes 115 detected in the image, in some cases, using the classification model system 170, which as further described below may be trained to facilitate identification of tags 102A-N with or without visual attributes 115 in the image. In this embodiment, the system application 153 may also determine the actual location data 116 (e.g., x, y, z coordinates) for each tag 102A-N captured in the image using the classification model system 170, which as further described below may be trained to determine locations of objects identified in an image and/or determine distances to the objects identified in the image.

The audio detection devices 136A-N may transmit (a stream of) audio data indicating the audio attributes 119 of audio signals detected within the inventory environment 103 to the system application 153 over the network 180. The system application 153 may identify the different tags 102A-N based on the audio attributes 119 indicated in the received audio data, in some cases, using the classification model system 170. As further described below, the classification model system 170 may be trained to facilitate identification of tags 102A-N with or without audio attributes 119. The system application 153 may then determine the actual location data 116 (e.g., x, y, z coordinates) for each tag 102A-N identified in the audio data using the classification model system 170. As further described below, the classification model system 170 may be trained to predict a location of the tag 102A-N based on a history of patterns between known locations of tags 102A-N and known audio attributes 119.

The management system 150 may also include a data store 156 (e.g., one or more memories, distributed or co-located). The data store 156 may store the tag data 112, schedules 114, visual attributes 115, audio attributes 119, location data 116, and rules 117, similar to the data store 110 of the reader devices 109A-N.

The classification model system 170 may be a server or system of servers that may employ artificial intelligence (AI) methods, classification methods, or computer vision methods for classifying input images using advanced hardware and software resources. While FIG. 1 illustrates the classification model system 170 as being separate from the management system 150, in some embodiments, the classification model system 170 may be provisioned in the classification management system 170. The classification model system 170 may run neural networks and AI models that have been previously trained with extensive training data to recognize patterns and features to perform object detection, identify and locate objects within images, perform image classification/labeling, etc. For example, the classification model system 170 may be trained to identify objects or visual markers (e.g., visual attributes 115) in a received image to identify corresponding tags 102A-N in the image. The classification model system 170 may also be trained to determine distances to the identified objects/visual markers/tags 102A-N in the image.

The classification model system 170 may be built using convolutional neural networks (CNNs), for example, and may scan images, detect features like edges, textures, and shapes, and use these features to classify objects detected in the images (e.g., as either a visual attribute 115 on a tag 102A-N or not). The classification model system 170 may be trained using a large dataset of labeled images from different angles, orientations, and distances from tags 102A-N. The labeled images identify known objects or visual attributes 115 on different types of tags 102A-N, identify known distances between the visual attributes 115 and the camera 130A-N, and/or identify known locations of the visual attributes 115 in an inventory environment 103. Once trained, the classification model system 170 may be used to classify new, unseen images by processing the images through the network layers of the classification model system 170, extracting the learned features, and making predictions based on the detected patterns to identify visual attributes 115 and determine distances/locations to the visual attributes 115.

In an embodiment, the camera application 133, application 108, or the system application 153 may provide captured images of tags 102A-N with visual attributes 115 to the classification model system 170. The images of tags 102A-N may be captured from different angles, orientations, and distances based on the position and orientation of the camera 130 capturing the image. The training of the classification model system 170 may enable the classification model system 170 to categorize the images captured from different angles, orientations, and distances together to identify tags 102A-N in the images and determine locations of the tags 102A-N in the images. The classification model system 170 may run various algorithms on received images to identify the visual attributes 115 in the images to identify the corresponding tags 102A-N in the images. In some cases, the classification model system 170 may run various algorithms on received images to determine the location of the visual attributes 115 in the images to obtain the location data 116 of the tags 102A-N in the images. The classification model system 170 may pass location data 116 back to the reader devices 106A-N and/or to the management system 150, and the reader devices 106A-N and/or management system 150 may store the location data 116 in association with corresponding tag data 112.

In addition, the classification model system 170 may run neural networks and AI models that have been previously trained with extensive training data to recognize patterns and features to perform audio data analysis and predictions. The classification model system 170 may be trained using a large dataset of labeled audio data based on audio signals received at microphones from different angles, orientations, and distances from tags 102A-N. For example, the classification model system 170 may be trained to identify audio attributes 119 from received audio data to identify corresponding tags 102A-N (e.g., to identify the audio attributes 119 of audio signals emitted from a tag, as opposed to other types of audio signals that may be detected in the inventory environment). The classification model system 170 may also be trained to determine distances from the audio emitting device 143 to the audio detection devise 136A-N.

The classification model system 170 may be built to distinguish between different sounds in audio signals based on the audio attributes 119 of the audio signals (e.g., using features like amplitude, frequency, pitch, and duration to identify and categorize sounds of the audio signals into ones that are coming from audio emitting devices 143 on tags 102A-N and ones that are not). The audio signals from the tags 102A-N may be received from different angles, orientations, and distances based on the position and orientation of the audio detection device 136A-N, and the training of the classification model system 170 may enable the classification model system 170 to categorize the audio signals received from different angles, orientations, and distances together to identify tags 102A-N and determine locations of the tags 102A-N. For instance, a neural network can be trained to classify sounds such as speech, music, and ambient noise by analyzing these attributes. The classification model system 170 may learn to recognize patterns and correlations between these features and the different sound categories during training. A labeled dataset containing various audio recordings and their corresponding sound categories may be used to train the classification model system 170 for audio signal identification and tag 102A-N location.

In an embodiment, the audio application 139, application 108, or system application 153 may provide audio data indicating the audio attributes 119 to the classification model system 170. The classification model system 170 may run various algorithms on the audio data to identify the tags 102A-N from which audio signals with audio attributes 119 are emitted. The classification model system 170 may also run various algorithms on the audio data to determine the location of the audio emitting devices 143 and thus obtain the location data 116 of the tags 102A-N. The classification model system 170 may pass location data 116 back to the reader devices 106A-N and/or to the management system 150, and the reader devices 106A-N and/or management system 150 may store the location data 116 in association with corresponding the tag data 112.

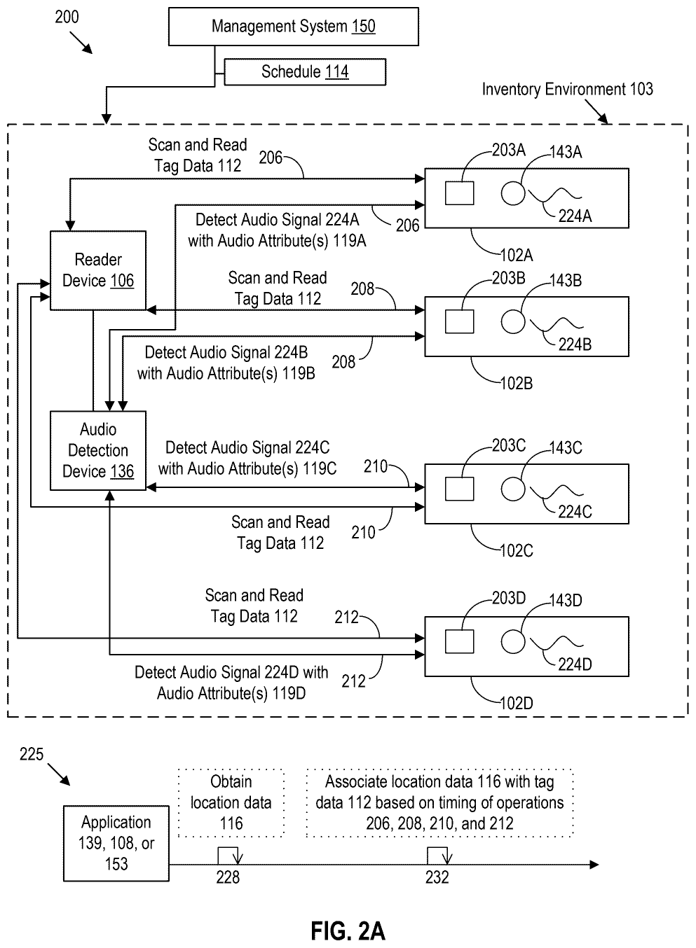

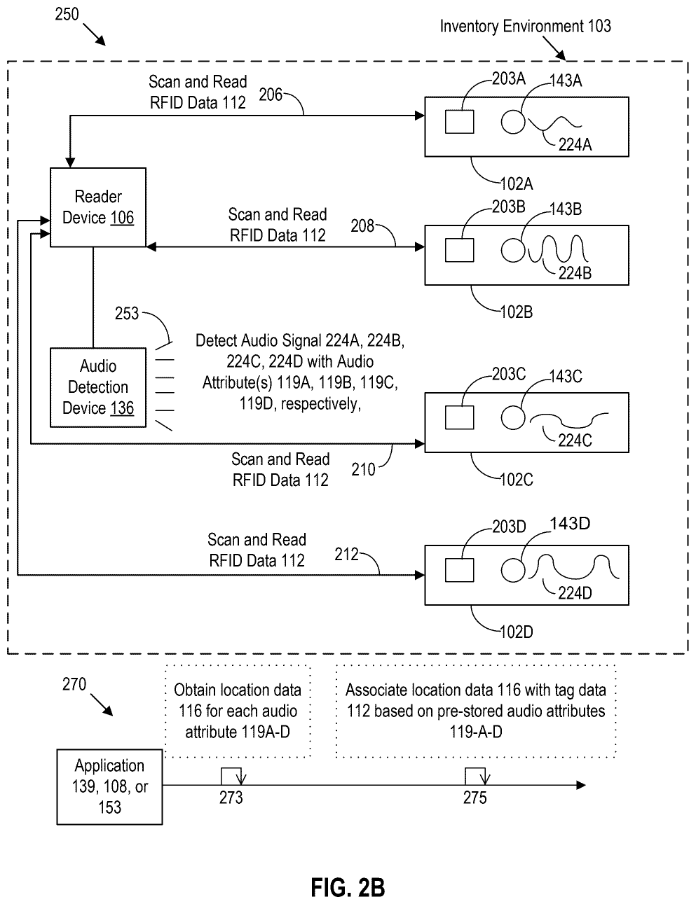

Referring now to FIGS. 2A and 2B, shown are two embodiments of registering tags 102A-N in an inventory environment 103. In particular, FIG. 2A illustrates an inventory system 200 including a reader device 106A-N (hereinafter referred to as “reader device 106”) and an audio detection device 136A-N (hereinafter referred to as “audio detection device 136”) that operate to sequentially register individual tags 102A-D separately. FIG. 2B illustrates an inventory system 250 including the reader device 106 and the audio detection device 136 that operate to register multiple tags 102A-D together (as opposed to individually).

Turning now specifically to FIG. 2A, shown is an inventory system 200 including the reader device 106, the audio detection device 136, and an exemplary four tags 102A, 102B, 102C, and 102D. While the inventory system 200 is shown as only including one reader device 106, one audio detection device 136, and four tags 102A-D, it should be appreciated that the inventory system 200 may include any number of reader devices 106, audio detection devices 136, and tags 102A-D. The reader device 106, the audio detection device 136, and the tags 102A-D shown in FIG. 2A are positioned within the inventory environment 103, such that the combination of the audio detection device 136 and the reader device 106 are positioned within the read zone and the audio zone of the tags 102A-D. The read zone is an area or distance from the tags 102A-D in which the reader device 106 is capable of accurately communicating with the tags 102A-D to receive data from the tags 102A-N, and the audio zone of the tags 102A-D is an area or distance from the tags 102A-D in which the audio detection device 136 is capable of clearly and accurately detecting audio signals emitted from audio emitting devices 143A-D of the tags 102A-D. It should be appreciated that the read zone and the audio zone for tags 102A-D may be the same area or may be different areas, particularly if obstacles are present between the tags 102A-D and the audio detection device 136 and reader device 106.

As mentioned above, the inventory system 200 is programmed to sequentially register individual tags 102A-D separately, in some embodiments, according to a predefined schedule 114. The schedule 114 may indicate specific time intervals, time windows, or time points, during which to time sync the reader device 106 and the audio detection device 136 to coordinate scanning and performing location detection of tags 102A-D individually. For example, the schedule 114 may indicate a first time window during which the reader device 106 is to complete scanning an individual tag 102A, 102B, 102C, or 102D (e.g., transmit signals to the tag 102A-D and receive tag data 112 from the tag 102A-D) and during which the audio detection device 136 is to receive audio signals 224A, 224B, 224C, or 224D from each of the individual tags 102A, 102B, 102C, or 102D), a second window during which the reader device 106 and the audio detection device 136 is to perform the same for another individual tag 102A, 102B, 102C, or 102D, a third time window during which the reader device 106 and the audio detection device 136 is to perform the same for yet another individual tag 102A, 102B, 102C, or 102D, and so on. In this case, the different time windows may be the same time duration such that reader device 106 and the audio detection device 136 are essentially configured to perform tag scanning and audio signal capturing across different tags 102A-D at a predefined frequency based on the same time duration. In one case, the reader device 106 may be programmed to scan the different tags 102A-D according to the schedule 114 (e.g., send signals to the different tags 102A-D according to a predefined frequency), and the audio detection device 136 may be programmed to receive the audio signals from an audio emitting device 143A-D of a respective tag 102A-D at the same or similar predefined frequency (e.g., a predefined number of milliseconds to account for the delay between a tag 102A-D receiving a signal and using the signal to power the audio emitting device 143A-D of the tag 102A-D).

In another embodiment, the reader device 106 may communicate data with the management system 150 after scanning a tag 102A-D such that the management system 150 instructs the audio detection device 136 to capture one or more detected audio signals 224A-D from the audio emitting device 143A-D of the tag 102A-D and then perform location detection of the tag 102A-D according to the embodiments disclosed herein. For example, the reader device 106 may scan a tag 102A-D according to the schedule 114, and transmit a message including a scan time, an identification of the reader device 106, an identification of an antenna that sent the signal to the tag 102A-D, a port associated with the reader device 106 and/or antenna, and a tag identifier (obtained from the tag data 112) of the tag 102A-D, to the management system 150. The system application 153, upon receiving this message, may instruct the audio application 139 at the audio detection device 136 to capture audio signals 224A-D from an audio emitting device 143A-D of the tag 102A-D identified in the message to perform location detection and identify the location of the tag 102A-D. The audio application 139 may then transmit a second message including a capture time that the audio detection device 136 captured the audio signal 224A-D from the tag 102A-D (which may be slightly different from the reader device 106 scan time), the identification of the reader device 106, the identification of the antenna and port, the tag identifier, and the captured audio signal 224A-D. The audio application 139 may also obtain audio data based on the audio signal 224A-D received from the tag 102A-D, in which the audio data indicates the audio attributes 119A-D of each of the audio signals 224A-D. In this case, the audio application 139, application 108, or the system application 153 may perform the computations to determine the location data 116 of the tag 102A-D using the audio attributes 119A-D of the audio signals 224A-D received from the tags 102A-D, individually.

In the example shown in FIG. 2A, the reader device 106 and/or the audio detection device 136 may receive the schedule 114 from the management system 150, after the management system 150 programmatically determines the schedule 114 (e.g., based on the type of reader device 106 and/or audio detection device 136) or receives the schedule 114 from an operator of the management system 150. Once the reader device 106 and/or audio detection device 136 receive and store/program the schedule 114, the reader device 106 and audio detection device 136 may begin individually registering the tags 102A-D.

As shown in FIG. 2A, each of the tags 102A-D may include the chip 203A-D and one or more audio emitting devices 143A-D (e.g., a speaker and/or a computer system 140 to provide additional power to the audio emitting device 143A-D). The audio emitting devices 143A-D may each emit a respective audio signal 224A-D, each having specific audio attributes 119A-D. For example, tag 102A includes a chip 203A and an audio emitting device 143A, which emits an audio signal 224A having one or more audio attributes 119A. Tag 102B includes a chip 203B and an audio emitting device 143B, which emits an audio signal 224B having one or more audio attributes 119B. Tag 102C includes a chip 203C and an audio emitting device 143C, which emits an audio signal 224C having one or more audio attributes 119C. Tag 102D includes a chip 203D and an audio emitting device 143D, which emits an audio signal 224D having one or more audio attributes 119D. In the example shown in FIG. 2A, each of the audio signals 224A-D are similar in nature and may have similar audio attributes 119A-D since each tag 102A-D is registered individually. However, in other embodiments, each of the audio signals 224A-D may be different from one another.

In the embodiment shown in FIG. 2A, the reader device 106 may individually scan each tag 102A-D and the audio detection device 136 may individually detect each tag 102A-D according to a time synchronization indicated in the schedule 114, as described above. For example, the reader device 106 and the audio detection device 136 may first perform operation 206. At operation 206, the reader device 106 may, based on a time indicated in the schedule 114, scan the tag 102A and the audio detection device 136 may, also based on the time indicated in the schedule 114, detect the audio signal 224 with audio attributes 119A from the tag 102A. The reader device 106 may scan the tag 102A by instructing an antenna of the reader device 106 or another separate antenna communicatively coupled to the reader device 106 to transmit a signal (e.g., a modulated signal with electromagnetic energy) to the tag 102A, and the tag 102A may use the energy from the signal to obtain power. Once powered up, the tag 102A may provide power to activate (e.g., provide power to) the audio emitting device 143A to emit audio signals 224A, and transmit tag data 112 stored at the memory of the chip 203A to the reader device 106. The audio detection device 136 may capture the audio signals 224A with audio attributes 119A from the tag 102A, and convert the audio signals 224A into audio data for further processing.

At this stage, an application (e.g., the audio application 139, application 108 at the reader device 106, and/or the system application 153 at the management system 150) may perform method 225. Turning now to method 225, the application may perform operation 228 to obtain (e.g., determine/calculate) the location data 116 of the tag 102A (e.g., 3D coordinates of the tag 102A). For example, the audio application 139 and/or the application 108 at the reader device 106 may identify the audio attribute 119A of the audio signal 224A (based on audio data provided to the classification model system 170). The audio application 139 and/or application 108 may use the classification model system 170 to determine a distance to or location of the tag 102A based on the identified audio attribute 119 of the audio signal 224A. In this case, operation 228 may be performed using audio-based identification and location methods enabled in the audio detection device 136 and/or reader device 106. Alternatively, the audio application 139 may transmit audio data associated with the audio signal 224A and describing the audio attributes 119A of the audio signal 224A to the system application 153, and the system application 153 may use the audio data and the classification model system 170 to identify the audio attribute 119A of the audio signal 224A and determine a distance to or location of the tag 102A based on the identified audio attribute 119 of the audio signal 224A. In this case, operation 228 may be performed using the classification model system 170 (e.g., by providing audio data associated with the audio signal 224A as input into the classification model system 170, and receiving the location data 116 back from the classification model system 170).

Then, at operation 232, either the audio application 139, application 108 at the reader device 106, or system application 153 at the management system 150 may associate the obtained location data 116 (e.g., audio-based location calculated using the audio signal 224A captured by the audio detection device 136) with the tag data 112 (e.g., received by the reader device 106 from the tag 102A and including a tag identifier of the tag 102) based on the time synching of performing operation 206 as indicated in the schedule 114. For example, the application 139, 108, or 153 may determine the time interval during which the reader device 106 and audio detection device 136 scanned the tag 102A based on the schedule 114, determine a scan time of scanning the tag 102A and receiving the tag data 112 from the tag 102A, and a capture time of receiving the audio signal 224A from the tag 102A. The application 139, 108, and/or 153 may then determine whether the scan time and the capture time are within the range of the time interval of the schedule 114 associated with reading the tag 102A. When the scan time and the capture time are within the range of the time interval of the schedule 114 associated with reading the tag 102A, the application 139, 108, and/or 153 may register the tag data 112 (e.g., tag identifier) of the tag 102A with the identified audio attributes 119A of the tag 102A and the determined location data 116 (e.g., audio-based location) of the tag 102A in the data store 110 and/or 156.

After completing method 225 to register tag 102A, the reader device 106 and audio detection device 136 may perform operations 208, 210, 212 and method 225 for each tag 102B, 102C, and 102D individually to register each of tag 102B, 102C, and 102C with the inventory system 200 (e.g., in data stores 110 and/or 156). For example, the reader device 106 and the audio detection device 136 may perform operation 208 to scan the tag 102B and capture an audio signal 224B indicating the audio attributes 119B from the tag 102B based on a time indicated in the schedule 114. Then, the application 139, 108, and/or 153 may perform method 225 to register the tag 102B with the inventory system 200. Next, reader device 106 and the audio detection device 136 may perform operation 210 to scan the tag 102C and capture an audio signal 224C indicating the audio attributes 119C from the tag 102C based on a time indicated in the schedule 114. Then, the application 139, 108, and/or 153 may perform method 225 to register the tag 102C with the inventory system 200. Next, reader device 106 and the audio detection device 136 may perform operation 212 to scan the tag 102D and capture an audio signal 224D indicating the audio attributes 119D from the tag 102D based on a time indicated in the schedule 114. Then, the application 139, 108, and/or 153 may perform method 225 to register the tag 102D with the inventory system 200. In this way, the inventory system 200 in FIG. 2A is programmed to register each of tags 102A, 102B, 102C, and 102D individually.

Turning now to FIG. 2B, shown is the inventory system 250, which is similar to the inventory system 200 of FIG. 2A, and includes the reader device 106, the audio detection device 136, and the exemplary four tags 102A, 102B, 102C, and 102D. Each of the four tags 102A-D may emit audio signals 224A-D that are different from one another, as shown in FIG. 2B (unlike the audio signals 224A-D in FIG. 2A that were similar to one another). In addition, unlike FIG. 2A, the inventory system 250 is programmed to register the tags 102A-D together, as opposed to individually. The registration of the tags 102A-D shown in FIG. 2 may not be based on a schedule 114, but instead may be based on pre-stored data describing the audio attributes 119 of different tags 102A-D that may be positioned in the inventory environment 103.

In this case, an operator may pre-scan each of the tags 102A-D to obtain the tag data 112 from the tags 102A-D and obtain the audio signals 224 of tags 102A-D and extract the audio attributes 119A-D of the audio signals 224A-D. The operator may then provide the tag data 112 of the tags 102A-D and the identified audio attributes 119A-D of the tags 102A-D to the management system 150 for storage at the data store 156. This pre-scan and storage at the management system 150 may be performed prior the tags 102A-D entering the inventory environment 103 or being coupled to items destined for storage at the inventory environment 103.

For example, an operator may operate a device (which may be the management system 150) to gather the tags 102A-D (before or after the tags 102A-D have been coupled to respective items), perform a scan on the tags 102A-D to receive the tag data 102A-D from the chips 203A-D of the tags 102A-D, and capture audio signals 224A-D from the audio emitting devices 143A-D of the tags 102A-D. The device may use the classification model system 170 to determine the audio attributes 119A-D of each of the audio signals 224A-D. For example, the determined audio attributes 119A-D may be in the form of audio data (e.g., a recording or a digitized version of the audio signal) or may be in the form of metadata describing the audio attributes 119A-D (e.g., pitch, tone, volume, etc.) of the audio signal 224A-D.

The operator may then provide, to the management system 150, the obtained tag data 112 of the tags 102A-D with the determined audio attributes 119A-D of each of the audio signals 224A-D received from of each of the tags 102A-D. The system application 153 at the management system 150 may store entries for each of the tags 102A-D in data stores 110 and/or 156, with the tag data 112 received from each of the tags 102A-D and the determined audio attributes 119A-D of each of the tags 102A-D. For example, a first entry for tag 102A may include a tag identifier 1 of tag 102A and an audio attribute 119A describing a pitch of the audio signal 224A, a second entry for tag 102B may include a tag identifier 2 of tag 102B and an audio attribute 119B describing a volume of the audio signal 224B, a third entry for tag 102C may include a tag identifier 3 of tag 102C and an audio attribute 119C describing a duration of the audio signal 224C, a fourth entry for tag 102D may include a tag identifier 4 of tag 102D and an audio attribute 119D describing harmonics of the audio signal 224D, and so on.

Once the tags 102A-D enter the inventory environment 103, the tags 102A-D may be scanned for identification and location for purposes. As shown in FIG. 2B, the reader device 106 may scan the tags 102A-D simultaneously or individually, at operations 206, 208, 210, and 212. At operation 253, the audio detection device 136 may then receive the audio signals 224A, 224B, 224C, 224D from audio emitting devices 143A, 143B, 143C, and 143D of all of the tags 102A, 102B, 102C, and 102D together within a single time period or duration. The captured audio signals 224A-D may clearly and completely indicate the audio attributes 119A-D of each respective audio signal 224A-D, and the audio application 139 may obtain audio data for each of the audio signals 224A-D indicative of the audio attributes 119A-D of the audio signals 224A-D.

At this stage, an application in the inventory system 103 (e.g., the audio application 139, application 108 at the reader device 106, and/or the system application 153 at the management system 150) may perform method 270. Turning now to method 270, the application may perform operation 273 to obtain (e.g., determine/calculate) the location data 116 of all of tags 102A-D (e.g., 3D coordinates of the tags 102A-D) based on the received audio signals 224A-D and the corresponding audio attributes 119A-D. This operation may be performed based on audio-based identification and location methods enabled in the audio detection device 136, reader device 106, and/or management system 150, and in some cases, using the classification model system 170 (e.g., by providing the audio signals 224A-D as input into the classification model system 170, and receiving the location data 116 back from the classification model system 170).

Then, at operation 275, the application 139, 108, or 153 may associate the obtained location data 116 (e.g., audio-based location calculated using the audio signals 224A-D received by the audio detection device 136) with the tag data 112 (e.g., received by the reader device 106 from the tag 102A and including a tag identifier of the tag 102) based on the previously stored audio attributes 119 of all of the tags 102A-D.

For example, the application 139, 108, or 153 may collect the tag data 112 from each of the tags 102A-D, the location data 116 of the tags 102A-D as determined based on the currently detected audio attributes 119A-D of the received audio signals 224A-D using the classification model system 170, and the audio signals 224A-D received from each of the tags 102A-D. The application 139, 108, or 153 may compare the currently detected audio attributes 119A-D with the stored audio attributes 119 to identify a match between the currently detected audio attributes 119A-D and the stored audio attributes 119. When a match between a currently detected audio attribute 119A-D and a stored audio attribute 119 is identified (e.g., when a match between a volume (e.g., audio attribute 119B) of a currently detected audio signal 224B and a pre-stored audio attribute 119 indicating a volume of an audio signal corresponds to a particular tag identifier), the application 139, 108, or 153 may obtain the tag data 112 or the tag identifier in the entry with the matching stored audio attribute 119. The application 139, 108, or 153 may then have identified the entries in the data store 156 corresponding to the identified tags 102A-D. The application 139, 108, or 153 may obtain the location data 116 calculated for each of the tags 102A-D (from operation 273) and add the location data 116 to the entry with the matching stored audio attributes 119A-D, such that the added location data 116 reflects the most recent location of the tags 102A-N.

The registration of the tags 102A-N may be completed when the location data 116 for the tags 102A-N have been added to the entries of the tags 102A-N in the data store 156. In some cases, the system application 153 may transmit the entries for the tags 102A-D with the tag data 112, audio attributes 119A-D, and location data 116 for each of the tags 102A-D to the reader devices 106 in the inventory environment 103. The reader devices 106 may store the entries in the data store 110.

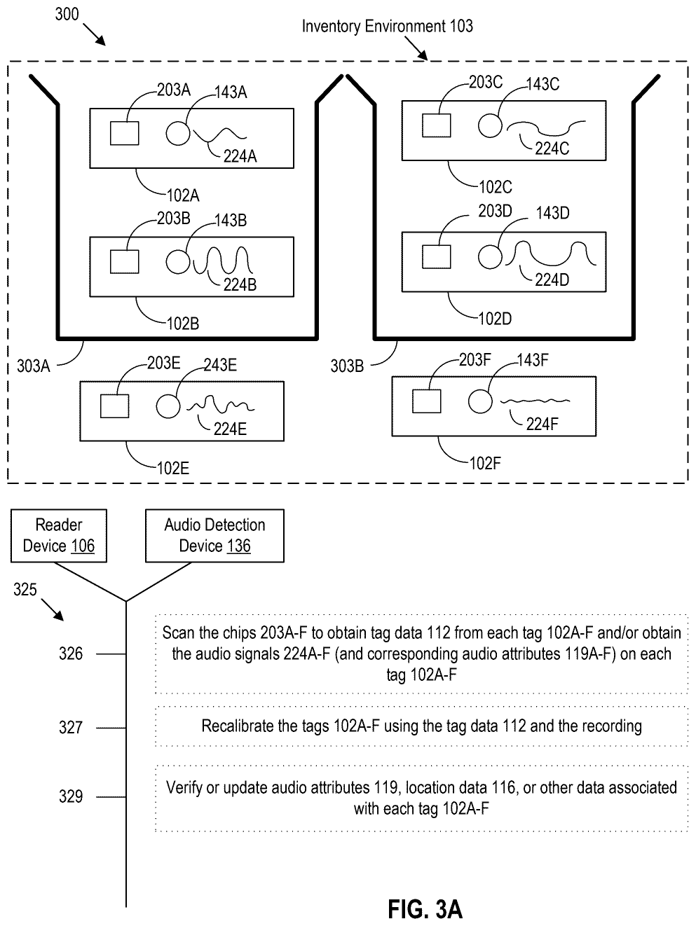

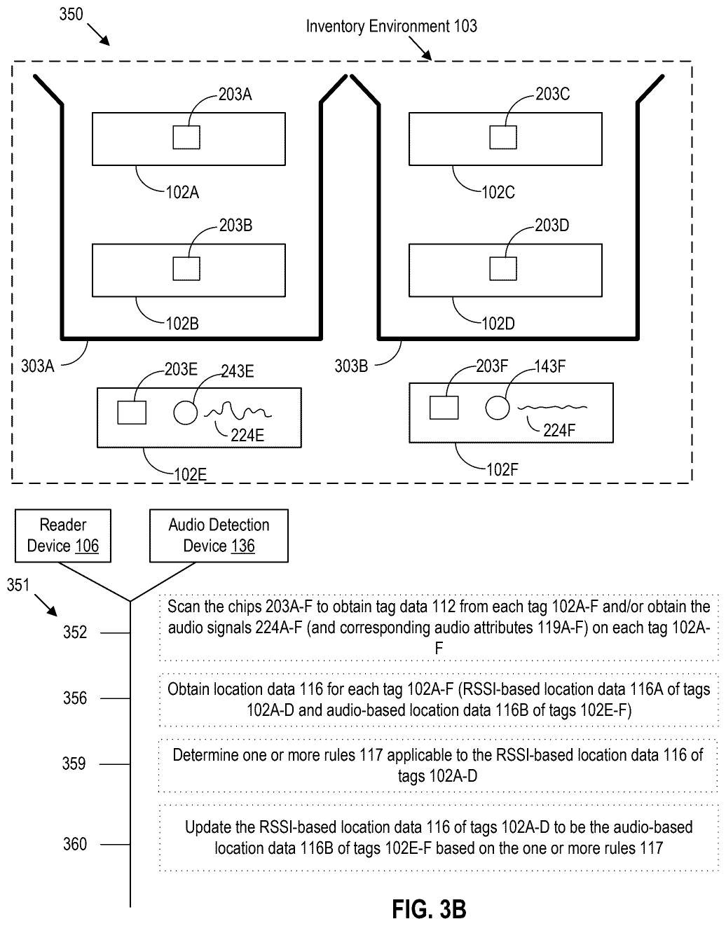

Referring now to FIGS. 3A and 3B, shown are diagrams of two embodiments of updating location data 116 of tags 102A-D in an inventory environment 103. In particular, FIG. 3A illustrates an inventory system 300 including a reader device 106 and an audio detection device 136 that operate to update location data 116 for tags 102A-E, in which each of the tags 102A-E have audio emitting devices 143A-E configured to emit audio signals 224A-E, respectively. Each audio signal 224A-E may be identified based on respective audio attributes 119, detectable by the audio detection device 136. FIG. 3B illustrates an inventory system 350 including a reader device 106 and an audio detection device 136 that operates to update location data 116 for tags 102A-E, in which only tags 102E and 102F have audio emitting devices 143E and 143F for emitting audio signals 224E and 224F for detection by the audio detection device 136.

Turning now to FIG. 3A, shown is an inventory system 300 including the reader device 106, the audio detection device 136, and an exemplary six tags 102A, 102B, 102C, 102D, 102E, and 102F. The reader device 106, the audio detection device 136, and the tags 102A-D are positioned within the inventory environment 103. The management system 150 may communicate with the reader device 106 and the audio detection device 136 over the network 180.

As mentioned above, each of the six tags 102A, 102B, 102C, 102D, 102E, and 102F include respective audio emitting devices 143A, 143B, 143C, 143D, 143E, and 143F. Each audio emitting device 143A, 143B, 143C, 143D, 143E, and 143F may be configured to emit an audio signal 224A, 224B, 224C, 224D, 224E, and 224F, each of which is detectable by the audio detection device 136. In particular, tag 102A includes the chip 203A and audio emitting device 143A, which when activated emits audio signal 224A having audio attributes 119A. Similarly, tag 102B includes the chip 203B and audio emitting device 143B, which when activated emits audio signal 224B having audio attributes 119B. Tag 102C includes the chip 203C and audio emitting device 143C, which when activated emits audio signal 224C having audio attributes 119C. Tag 102D includes the chip 203D and audio emitting device 143D, which when activated emits audio signal 224D having audio attributes 119D. Tag 102E includes the chip 203E and audio emitting device 143E, which when activated emits audio signal 224E having audio attributes 119E. Tag 102F includes the chip 203F and audio emitting device 143F, which when activated emits audio signal 224F having audio attributes 119F.

FIG. 3A illustrates the current location of each of tags 102A-F. For example, as shown in FIG. 3A, the tags 102A-D are located in two areas 303A-B in the inventory environment 103, and tags 102E-F are located outside of the two areas 303A-B. Specifically, tag 102A and 102B are located within area 303A, and tag 102C and tag 102D are located within area 303B. Tag 102E may be considered as located within the area 303A as well even though FIG. 3A illustrates tag 102E as being positioned adjacent to and underneath area 303A. Similarly, tag 102F may be considered as located within the area 303B as well, even though FIG. 3A illustrates tag 102F as being positioned adjacent to and underneath area 303B.

Each of the areas 303A and 303B may correspond to 3D areas or zones within the inventory environment 103 in which one or more tags 102A-D (coupled to items) may be at least temporarily located for a period of time. For example, area 303A and 303B may correspond to separate but adjacent storage bins on a rack in the inventory environment 103. Each storage bin (e.g., each area 303A and 303B) may at least temporarily store items attached to the tags 102A-D. To this end, the tags 102A-D may be mobile within the inventory environment 103, and may not always remain stored in the areas 303A-B, but the storage bins themselves may remain fixed. Meanwhile, the tags 102E and 102F may remain fixed in a position relative to each of the storage bins, and thus fixed in a position to identify each of the areas 303A-B. For example, the tag 102E may be positioned on the front of a shelf on the rack supporting the storage bin for area 303A, and tag 102F may be positioned on the front of the shelf on the rack supporting the storage bin for area 303B.

Turning now to method 325 in FIG. 3A, it may be assumed that the tags 102A-F and the most recent location data 116 for each of the tags 102A-F may have already been registered with the reader device 106 and/or the management system 150. It may also be assumed that the most recent location data 116 for the tags 102A-F may be audio-based location data 102A-F, and thus reflect relatively accurate locations of the tags 102A-F.

At operation 326, the reader device 106 and the audio detection device 136 may perform a scan of the tags 102A-F in the inventory environment 103 to obtain tag data 112 from each tag 102A-F and/or obtain (e.g., capture) an updated audio signals 224A-F and corresponding audio attributes 119A-F from each of the tags 102A-F. The scan of the tags 102A-F may involve the reader device 106 or antenna communicatively coupled to the reader device 106 to transmit a signal to the tags 102A-F, and then receive tag data 112 from each of the tags 102A-F. The audio detection device 136 may then capture updated audio signals 224A-F, reflecting any and all updates to the audio attributes 119A-F associated with the audio signals 224A-F emitted from each of the tags 102A-F. The audio application 139, the application 108 at the reader device 106, and/or the system application 153 may perform the audio processing steps (in some cases using the classification model system 170) to obtain updated location data 116 for each of the audio signals 224A-F based on the audio attributes 119A-F, and thus for each of the tags 102A-F.

At operation 327, the signals containing the tag data 112 received by scanning each of the tags 102A-F and/or the updated audio signals 224A-F and audio attributes 119A-F from each of the tags 102A-F may be used to recalibrate the tags 102A-F. For example, the audio signals 224A-F indicating the latest version of the audio attributes 119A-F may identify changes to the originally registered audio attributes 119A-F (e.g., lower volume, different harmonics, shorter duration, etc.), and the latest version of the audio attributes 119A-F may be used to update the registered audio attributes 119A-F stored with the tags 102A-F. The signal received with the tag data 112 may also be used by the reader device 106 to record updates to the signal received from the tags 102A-F (e.g., the strength, RSSI intensity, power, read range, and any other issues (e.g., missed reads or inconsistent data) associated with the tags 102A-F).

At operation 329, the reader device 106 may use the recalibration to verify and/or update the audio attributes 119A-D, location data 116, and/or other data associated with each tag 102A-F. For example, when the registered location data 116 of tag 102A was associated with a first position in the inventory environment 103, but at a subsequent time, the tag 102A was moved to the storage bin in area 303A, the recalibration of the tag 102A may be used to update the location data 116 of tag 102A to be the audio-based location of the tag 102A in the area 303A.

Turning now to FIG. 3B, shown is the inventory system 350, which is similar to the inventory system 300 of FIG. 3A in that the tags 102A and 102B are positioned in a first storage bin in area 303A, tag 102E is positioned on a rack and in association with the area 303A, tags 102C and 102D are positioned in a second storage bin in area 303B, and tag 102F is positioned on a rack and in association with the area 303B. However, unlike inventory system 300 of FIG. 3A, the tags 102A, 102B, 102C, and 102D are lightweight tags that do not include any audio emitting devices 143A-D for emitting audio signals 224A-D with audio attributes 119A-F that may be detectable by the audio detection device 136 (or visual attributes 115 that may be detected by the camera 130). Tags 102E and 102F however do still include audio emitting devices 143E and 143F for emitting audio signals 224E and 224F with audio attributes 119E and 119F, each of which may be detectable by the audio detection device 136.

Turning now to method 351 in FIG. 3B, it may be assumed that the tags 102A-F and the most recent location data 116 for each of tags 102A-F may have already been registered with the reader device 106 and/or the management system 150. It may also be assumed that the most recent location data 116 for lightweight tags 102A-D may be RSSI-based location data (e.g., computed based on a signal strength received from the tags 102A-D), while the most recent location data 116 for tags 102E-F may be audio-based location data (e.g., determined based on the audio signals 224E-F received from the audio emitting devices 143E-F of the tags 102E-F).

At operation 352, the reader device 106 may scan the chips 203A-F in tags 102A-F to obtain tag data 112 from each of the tags 102A-F, and the audio detection device 136 may only receive audio signals 224A-F from audio emitting devices 143E-F, since tags 102A-D do not include audio emitting devices 143A-D. Audio signals 224E-F may include audio attributes 119E-F, which may be used by an application for tag identification and location detection.

At operation 356, the audio application 139, application 108 at the reader device 106, and/or the system application 153 at the management system 150 may determine updated location data 116 for each of the tags 102A-F. For example, the application 139, 108, and/or 153 may calculate the location data 116 for each of the lightweight tags 102A-D based on the signal strength of the signal carrying the tag data 112 received from each of tags 102A-D. This location data 116 for tags 102A-D may be RSSI-based location data 116A. Meanwhile, the application 139, 108, and/or 153 may use the classification model system 170 to determine the location data 116 for each of the tags 102E-F based on the received audio signals 224E-F and corresponding audio attributes 119E-F. This location data 116 for tags 102E-F may be the audio-based location data 116B, which may be more accurate than the RSSI-based location data 116A.

The reader device 106 and/or the management system 150 may determine whether the RSSI-based location data 116A for tags 102A-D applies to a rule 117. For example, the reader device 106 and/or the management system 150 may maintain a first rule 117 indicating that RSSI-based location data 116A in area 303A may be updated to audio-based location data 116B associated with the same area 303A (assuming the location of the tag 102E is associated with the same area 303A since the tag 102E is positioned adjacent to and underneath the area 303A or even within area 303A). In addition, the reader device 106 and/or the management system 150 may maintain a second rule 117 indicating that RSSI-based location data 116A in area 303B may be updated to audio-based location data 116B associated with the same area 303B (assuming the location of the tag 102F is associated with the same area 303B since the tag 102F is positioned adjacent to and underneath the area 303B or even within area 303B).

At operation 359, the reader device 106 and/or the management system 150 may determine a rule 117 applicable to the determined RSSI-based location data 116A for tags 102A-D. As mentioned above, the reader device 106 and/or the management system 150 may maintain two rules 117 applicable to areas 303A and 303B, such that the RSSI-based location data 116A for tags 102A-B is to be updated to the audio-based location data 116B of tag 102E, while the RSSI-based location data 116A for tags 102C-D is to be updated to the audio-based location data 116B of tag 102F. At operation 360, the reader device 106 and/or the management system 150 may apply the rules 117 to update the RSSI-based location data 116A for tags 102A-B to the audio-based location data 116B of tag 102E and update the RSSI-based location data 116A for tags 102C-D to the audio-based location data 116B of tag 102F.

In another embodiment, a rule 117 may indicate that when that RSSI-based location data 116A in area 303A may be updated to audio-based location data 116B associated with the same area 303A when image-based location data for the same area 303A is not available, but may be updated to the image-based location data for the same area 303A when available. For example, when a tag 102E has been registered with audio-based location data 116 and image-based location data (as described in the Tag Location Detection Patent Application), the location data 116 for the tag 102E may be updated to the image-based location data even though audio-based location data 116 is available. This may be because the image-based location data may be more accurate than the audio-based location data 116.

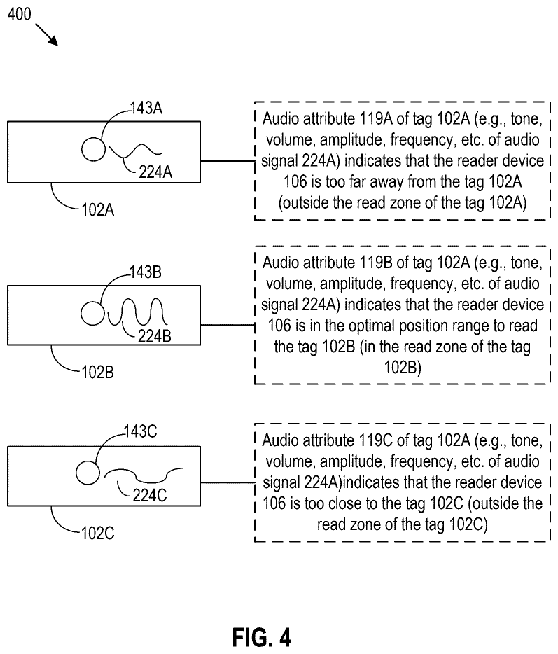

Referring now to FIG. 4, shown is a diagram illustrating examples of different types of alerts 400 that may be audibly presented on three exemplary tags 102A, 102B, and 102C according to various embodiments of the disclosure. In the example shown in FIG. 4, the tags 102A-C each include an audio emitting device 143A-C, respectively. Each of the tags 102A-C may be configured to trigger the audio emitting devices 143A-C to emit audio signals 224A-C (also referred to herein as “alert signals”) having different audio attributes 119A-C indicative of different alerts 400, respectively. The different audio attributes 119A-C of the audio signals 224A-C emitted by the audio emitting devices 143A-C may be based on data associated with a reader device 106 transmitting signals to the tags 102A-C. While the tags 102A-C shown in FIG. 4 are separate tags, it should be appreciated that a single tag 102A-C may display the alerts shown in FIG. 4 at different times.

The alerts 400 may be triggered dynamically based on various factors, and in particular, in response to a radio frequency signal received from a reader device 106. In an embodiment, a duration, volume, pitch, harmonic, or other audio attribute 119A-C of the audio signals 224A-C may be dynamically set based on a reader device 106, or more specifically, based on a distance between the reader device 106 and the tag 102A-C. For example, as shown in FIG. 4, the audio signal 224A may be emitted at a first volume to indicate first information to the user of the reader device 106, the audio signal 224B may be emitted at a second volume to indicate second information to the user of the reader device 106, and the audio signal 224C may be emitted at a third volume to indicate third information to the user of the reader device 106.

For example, the indicated information may relate to whether the reader device 106 is in the optimal read zone of the tag 102A-C. Referring specifically now to tag 102A in FIG. 4, as the user with the reader device 106 approaches the tag 102A, the audio signal 224A having a first audio attribute 119A (e.g., a tone, volume, amplitude, frequency, etc.) may be emitted by the audio emitting device 143A as shown in FIG. 4 to indicate that the reader device 106 is too far away from the tag 102A (e.g., outside of the read range of the tag 102A). For example, the tag 102A, or the chip 203A of tag 102A, may be preconfigured to set the audio emitting device 143A to emit audio signals 224A with the first audio attribute 119A based on a detected distance between the reader device 106/audio detection device 136 and the tag 102A, which may be determined by the reader device 106. The reader device 106 may then transmit a radio frequency signal to the tag 102A to trigger the audio emitting device 143A to emit audio signals 224A with the first audio attribute 119A. For example, the audio emitting device 143A may emit audio signals 224A at a high pitch to indicate that the reader device 106 is too far away from the tag 102A.

Referring specifically now to tag 102B, as the user with the reader device 106 approaches the tag 102B, the audio signal 224B having a second audio attribute 119B may be emitted by the audio emitting device 143B as shown in FIG. 4 to indicate that the reader device 106 is at an optimal distance from the tag 102B to read the tag 102B (e.g., inside of the read zone of the tag 102B). For example, the tag 102B, or the chip 203B of tag 102B, may be preconfigured to set the audio emitting device 143B to emit audio signals 224B with the second audio attribute 119B based on a detected distance between the reader device 106/audio detection device 136 and the tag 102B, which may be determined by the reader device 106. The reader device 106 may then transmit a radio frequency signal to the tag 102B to trigger the audio emitting device 143B to emit audio signals 224B with the second audio attribute 119B. For example, the audio emitting device 143B may emit audio signals 224B at a medium pitch to indicate that the reader device 106 is inside the read zone of the tag 102B.

Referring specifically now to tag 102C, as the user with the reader device 106 approaches the tag 102C, the audio signal 224C having a third audio attribute 119C may be emitted by the audio emitting device 143C as shown in FIG. 4 to indicate that the reader device 106 is too close to the tag 102C (e.g., outside of the read zone of the tag 102B). For example, the tag 102C, or the chip 203C of tag 102C, may be preconfigured to set the audio emitting device 143C to emit audio signals 224C with the third audio attribute 119C based on a detected distance between the reader device 106/audio detection device 136 and the tag 102C, which may be determined by the reader device 106. The reader device 106 may then transmit a radio frequency signal to the tag 102C to trigger the audio emitting device 143C to emit audio signals 224C with the third audio attribute 119C. For example, the audio emitting device 143C may emit audio signals 224C at a low pitch to indicate that the reader device 106 is too close to the tag 102C.

The information conveyed by the different audio attributes 119A-C may also signal other types of information. For example, the audio attributes 119A-C may be dynamically set to indicate predefined audio characteristics or features based on a power level of a tag 102A-C, based on received signal intensity of the tag 102, based on a type of reader device 106, etc.

In an embodiment, a combination of audio signals received from multiple audio emitting devices 143A-C may form the different audio attributes 119A-C. In other words, the audio signals analyzed from each tag 102A-C may be separated when multiple audio signals from different audio emitting devices 143A-C are received from each tag 102A-C. The audio signals from each tag 102A-C may be combined to generate the audio data for each tag 102A-C, with the audio attribute 119A-C for each tag 102A-C describing the combined audio signals from each tag 102A-C.

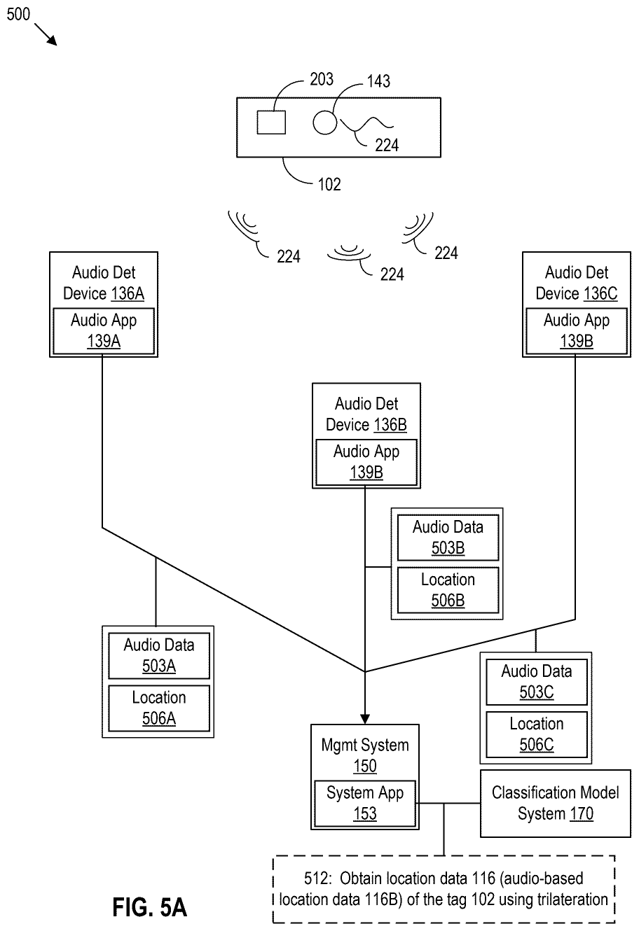

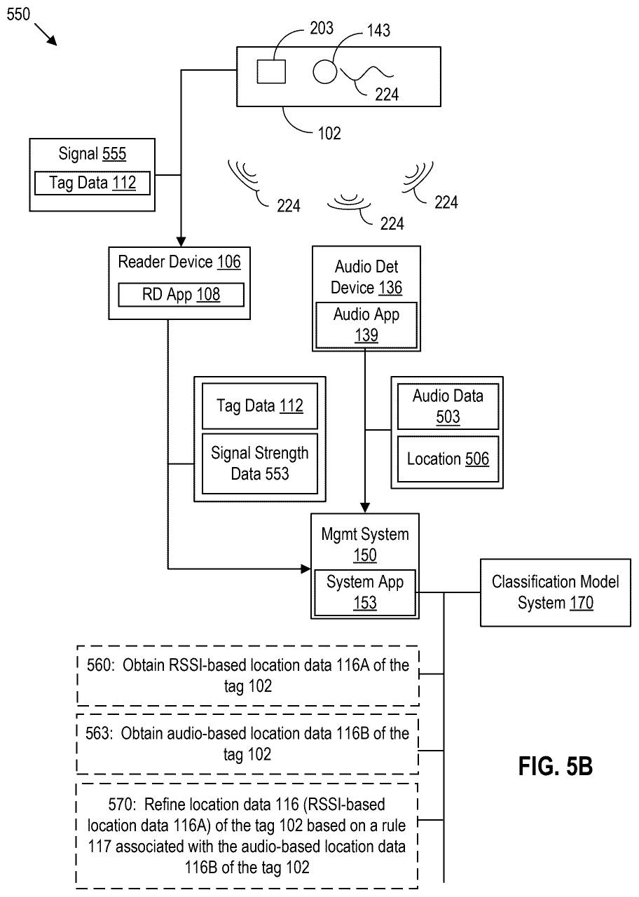

Referring now to FIGS. 5A and 5B, shown are diagrams illustrating two embodiments of obtaining location data 116 (e.g., audio-based location data 116B) of a tag 102. In particular, FIG. 5A illustrates an inventory system 500 including three audio detection devices 136A-C (e.g., microphones) that work together to obtain audio-based location data 116B of the tag 102 using trilateration methods. FIG. 5B illustrates an inventory system 550 including only one audio detection device 136 that obtains audio-based location data 116 of the tag 102 to refine RSSI-based location data 116A of the tag 102.

Turning now specifically to FIG. 5A, shown is the inventory system 500 including a single tag 102 and three audio detection devices 136A-C, each of which is communicatively coupled to the management system 150. While only one tag 102 and three audio detection devices 136A-C are shown in FIG. 5A, it should be appreciated that the inventory system 500 may include any number of tags 102 and audio detection devices 136A-C. The tag 102 includes a chip 203 and an audio emitting device 143 configured to emit audio signals 224 toward each of the audio detection devices 136A-C. Each of audio detection devices 136A-C may be positioned at different locations within a read zone and an audio zone of the tag 102. Each of the audio detection devices 136A-C include audio applications 139A-C, respectively, for receiving an audio signal 224 from the tag 102, and obtaining audio data 503A-C indicating the audio attributes 119 of the audio signal 224. The audio data 503A-C may be associated with the same audio signal 224 with the same audio attribute 119, but the audio attributes 119 may be perceived/received differently at each of the audio detection devices 136A-C due to the relative location of the audio detection devices 136A-C with respect to the tag 102. Therefore, the audio data 503A-C may include different values describing the audio attributes 119 of the audio signal 224 received at each of the different audio detection devices 136A-C. For example, the audio signal 224 may have a louder volume at audio detection device 136B than at audio detection device 136C since audio detection device 136B is farther away from the tag 102 than audio detection device 136C. To this end, the audio data 503B may have a different value describing the audio attribute 119 of the audio signal 224 received at the audio detection device 136B than the value describing the audio attribute 119 of the audio signal 224 received at the audio detection device 136C in the audio data 503C. The classification model system 170 may be able to use the different values in the audio data 503A-C to determine a distance from the respective audio detection device 136A-C to the tag 102.

In the embodiment shown in FIG. 5A, after the tag 102 obtains power (e.g., via a signal received from a reader device 106 and/or using a power source of the computer system 140), the tag 102 may trigger the audio emitting device 143 to emit an audio signal 224 (e.g., radially outward) toward the audio detection devices 136A-C. The audio detection devices 136A-C may each receive the audio signal 224 (e.g., at different times based on the positions of each of the audio detection devices 136A-C relative to the tag 102). The audio applications 139A-C may each determine audio data 503A-C associated with the audio signal 224 and indicative of the audio attributes 119 of the audio signal 224 as received at the respective audio detection device 136A-C, as described above. The audio data 503A may represent the audio signal 224 received at the audio detection device 136A and include values representing the audio attribute 119 of the audio signal 224 as received by the audio detection device 136A. Audio data 503B may represent the audio signal 224 received at the audio detection device 136B and include values representing the audio attribute 119 of the audio signal 224 as received by the audio detection device 136B. Audio data 503C may represent the audio signal 224 received at the audio detection device 136C and include values representing the audio attribute 119 of the audio signal 224 as received by the audio detection device 136A.

The audio application 139A-C may then each transmit the respective audio data 503A-C with a respective location 506A-C of the audio detection device 136A-C to the management system 150. For example, the location 506A-C of each audio detection device 136 may refer to 3D coordinates (e.g., GPS coordinates) or coordinates relative to the inventory environment 103. Audio application 139A of audio detection device 136A may transmit audio data 503A and a location 506A of the audio detection device 136A to the management system 150. Audio application 139B of audio detection device 136B may transmit audio data 503B and a location 506B of the audio detection device 136B to the management system 150. Audio application 139C of audio detection device 136C may transmit audio data 503C and a location 506C of the audio detection device 136A to the management system 150.

The management system 150 may thus receive different audio data 503A-C regarding the same audio signal 224 from three different audio detection devices 136A-C. The system application 153 at the management system 150 may then perform operation 512 using the classification model system 170 to obtain location data 116 (e.g., accurate audio-based location data 116B) of tag 102A using the audio data 503A-C and locations 306A-C based on trilateration methods. For example, the system application 153 may use the classification model system 170 to determine a distance between each audio detection device 136A-C and the tag 102 based on the audio attributes 119 indicated in the audio data 503A-C and the location 506A-C of each audio detection device 136A-C. Again, the classification model system 170 may be trained with labeled data indicative of distances between microphones and speakers based on audio signals received from the speakers and known locations of the microphones and speakers. The system application 153 may then perform trilateration based on the known locations 303A-C of the audio detection devices 136A-C and the determined distances between each audio detection device 136A-C and the tag 102 to obtain the audio-based location data 116B of tag 102. For example, the system application 153 may use the locations 303A-C as reference points and the determined distances to pinpoint the exact location of the tag 102. The location data 116 may then be stored at the data store 156 in a record in association with the tag 102.

Turning now to FIG. 5B, shown is inventory system 550, which is similar to inventory system 500 of FIG. 5A. However, unlike inventory system 500 of FIG. 5A, inventory system 550 of FIG. 5B only includes one audio detection device 136. FIG. 5B also shows inventory system 550 of FIG. 5B as including a reader device 106 (although it should be appreciated that inventory system 500 of FIG. 5A also includes a reader device 106).

In the inventory system 550 of FIG. 5B, the reader device 106 may first transmit an interrogation signal (e.g., a radio frequency signal) to the tag 102. The interrogation signal may include a modulated signal triggering the signal 555 to transmit tag data 112 back to the requesting reader device 106, which may be overlaid by a radio signal that may be used by the tag 102 to obtain power. The chip 203 on the tag 102 may then harvest the power (in some cases, additionally using a power source of an attached computer system 140), which may be used by the audio emitting device 143 of the tag 102. The chip 203 on the tag 102 may obtain tag data 112 stored at the chip 203 and transmit the tag data 112 back to the reader device 106 in a signal 555. The audio emitting device 143 may also transmit audio signals 224 in a direction of the audio detection device 136 using the obtained power (in some cases, with the additional power source).

The application 108 at the reader device 106 may receive the signal 555 with the tag data 112 and in some cases, store the tag data 112 locally at data store 110. The application 108 may also determine signal strength data 553 indicating a signal strength of the signal 555 received from the tag 102. For example, the signal strength data 553 may indicate the RSSI of the signal 555 received from the tag 102, which may be determined by measuring a power of the signal 555 received from the tag 102. The application 108 may use the radio transceiver 109 and/or antenna of the reader device 106 to measure the amplitude or power level of the received signal 555 (e.g., by evaluating a voltage or current of the signal 555 within the receiver circuitry). The reader device 106 may transmit the signal strength data 553 with the tag data 112 to the management system 150.

The audio application 139 of the audio detection device 136 may obtain the audio data 503 associated with the audio signal 224 and indicating the audio attributes 119 of the audio signal 224, as described above. The audio application 139 may transmit the audio data 503 with the known location 506 of the audio detection device 136 to the management system 150.

The system application 153 at the management system 150 may first perform operation 560 to obtain RSSI-based location data 116A of the tag 102 based on the signal strength data 553 received from the reader device 106. For example, the system application 153 may use the RSSI value carried in the signal strength data 553 to estimate the distance between the reader device 106 and the tag 102, with higher RSSI values generally indicating closer proximity and lower values indicating greater distances.

The system application 153 may then perform operation 563 using the classification model system 170 to obtain audio-based location data 116B of the tag 102 based on the audio data 503 and location 506 received from the audio detection device 136, as described above. For example, the system application 153 may provide the audio data 503 describing the audio attributes 119 of the audio signals 224 to the classification model system 170 to receive an estimate of a distance between the audio detection device 136 and the tag 102. At this stage, the system application 153 may set the location data 116 of the tag 102 as the RSSI-based location data 116A of the tag 102, and the management system 150 may also separately store the audio-based location data 116B of the tag 102.

The system application 153 may then identify a rule 117 indicating whether and how to refine the location data 116 of the tag 102 based on a rule 117 associated with the audio-based location data 115B of the tag 102. The rule 117 may indicate that when a single distance between the audio detection device 136 and the tag 102 is determined (as opposed to three distances that may be used to perform trilateration for location determination), the single distance may be used to refine the location data 116 of the tag 102 (e.g., the RSSI-based location data 116A of the tag 102). At operation 570, the system application 153 may refine the location data 116 of the tag 102 (e.g., the RSSI-based location data 116A of the tag 102) based on the rule 117, for example, modifying the location data 116 to be the audio-based location data 116B of the tag 102. For example, the RSSI-based location data 116A may be adjusted based on the distance determined in operation 563 to further correct the location data 116 of the tag 102. In this way, even when there are not enough audio detection devices 136 in the read zone and audio zone of the tag 102 to provide data for trilateration of the tag 102, the audio-based location data 116B may still be used to further correct the location data 116 or RSSI-based location data 116A.

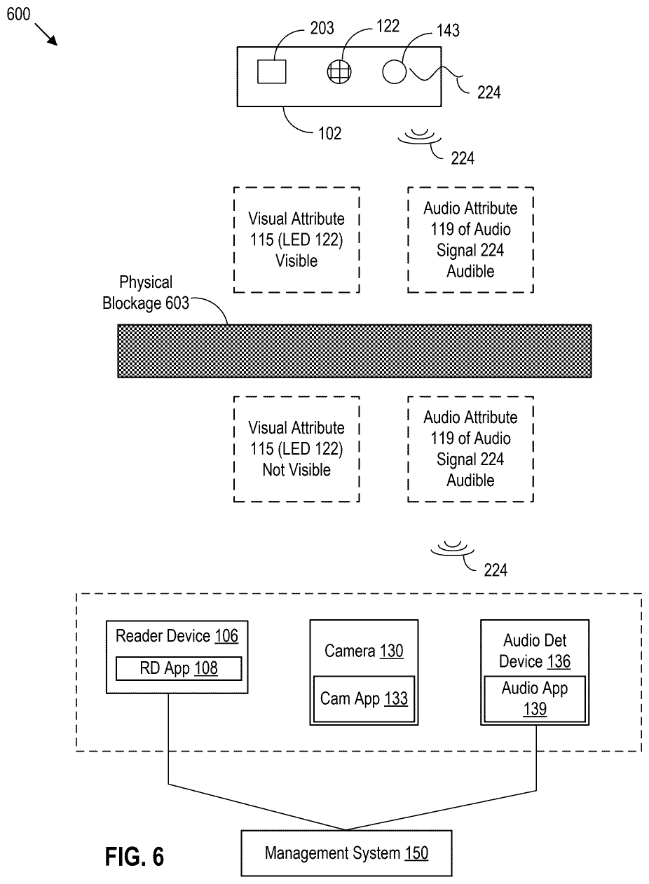

Referring now to FIG. 6, shown is an inventory system 600 including a reader device 106 communicatively coupled to or including a camera 130 and an audio detection device 136, which may work together to read a tag 102 and determine a location of the tag 102. The tag 102 shown in FIG. 6 may be an enhanced tag 102 including both visual attributes 115 (e.g., the LED 122) and audio attributes 119 (e.g., the audio emitting device 143 configured to emit the audio signal 224). In the example shown in FIG. 6, a physical blockage 603 or physical obstruction may be disposed in between the camera 130 (and the reader device 106 and audio detection device 136) and the tag 102. For example, the physical blockage 603 may be a crate, a box, a person, or other item large enough to physically block the camera 130 from being able to capture an image depicting a visual attribute 115 (e.g., the LED 122) on the tag 102.

In this case, it may be particularly beneficial that the reader device 106 is also coupled to the audio detection device 136 and the tag 102 also includes the audio emitting device 143 for emitting the audio signal 224. As shown in FIG. 6, the audio signal 224 may not be obstructed by the physical blockage 603. While the camera 130 may not be in a position or area to capture the visual attribute 115 of the tag 102, the audio detection device 136 may still be capable of receiving the audio signal 224. That is, the audio signal 224 may travel from the tag 102 around and through the physical blockage 603 to the audio detection device 136 when the audio detection device 136 is in the audio zone of the tag 102. In other words, the reader device 106 may use the audio detection device 136 to identify the tag 102 and obtain location data 116 for the tag 102 (as described herein). Therefore, the inventory system 600 shown in FIG. 6 provides for a more robust and enhanced method for modifying and refining location data 116 of tags 102, even when tags 102 are not visually detectable by the camera 130.

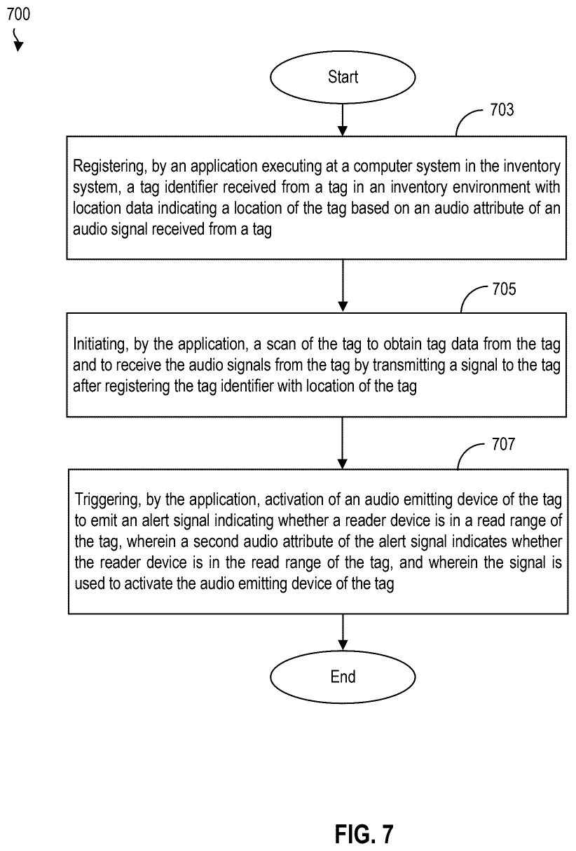

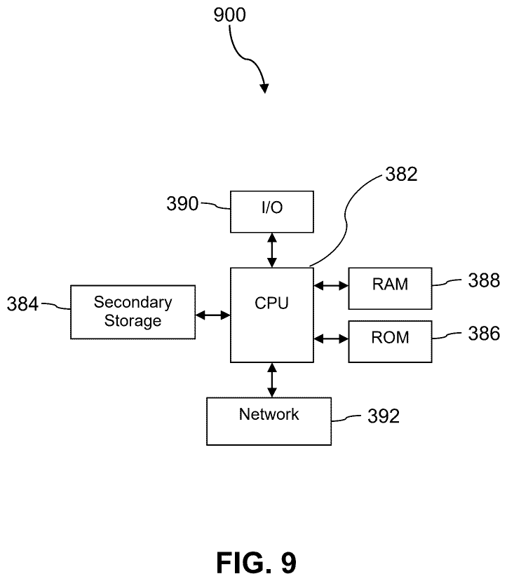

Turning now to FIG. 7, shown is a method 700 for optimizing performance of an inventory system 200, 250, 300, 350, 500, 550, 600 by associating tags 102 with audio-based location data 116B according to various embodiments of the disclosure. Method 700 may be implemented by an inventory system (e.g., the inventory system 200, 250, 300, 350, 500, 550, 600). In embodiments, the method 700 may be implemented using a computer system with components as shown in FIG. 9. As illustrated, method 700 of FIG. 7 includes a number of enumerated operations, but embodiments of the operations in FIG. 7 may include additional operations before, after, and in between the enumerated operations. In some embodiments, one or more of the enumerated operations may be omitted or performed in a different order. Method 700 may be performed by an application executing at a computer system, and the application may refer to the audio application 139 at the audio detection device 136, the application 108 at the reader device 106, and/or the application 153 at the management system 150.

At step 703, method 700 comprises registering, by the application, a tag identifier (e.g., in the tag data 112) received from a tag 102 in an inventory environment 103 with location data 116 indicating a location of the tag 102 based on an audio attribute 119 of an audio signal 224 received from the tag 102. At step 705, method 700 comprises initiating, by the application, a scan of the tag 102 to obtain tag data 112 from the tag 102 and to receive the audio signals 224 from the tag 102 by transmitting a signal to the tag 102 after registering the tag identifier with the location data 116 of the tag 102. At step 707, method 700 comprises triggering, by the application, activation of an audio emitting device 143 of the tag 102 to emit an alert signal (e.g., another audio signal 224, as described above with reference to FIG. 4) indicating whether a reader device 106 is in a read range of the tag 102. The read range may refer to a distance from the tag 102 corresponding to a read zone of the tag 102 (or an area around the tag 102 in which the tag 102 may accurately and clearly communicate with the reader device 106). An audio attribute 119 of the alert signal may indicate whether the reader device 106 is in the read range of the tag 102, and the signal is used to activate the audio emitting device 143 the tag 102.

Method 700 may further comprise additional attributes and/or steps not explicitly shown in FIG. 7. In an embodiment, registering the tag identifier of tag 102 with the location data 116 of the tag comprises initiating, by the application, a prior scan of the tag 102 at a first time according to a predefined schedule 114 to read the tag identifier from the tag 102, receiving, by an audio detection device 136 in the reader device 106, the audio signal 224 from the audio emitting device 143 of the tag 102 at the first time according to the predefined schedule 114, determining, by the application using the classification model system 170, the location data 116 of the tag 102 based on the audio attribute 119 of the audio signal 224, and storing, by the application, the tag identifier with the location data 116 at a data store 110, 156 in the inventory system 200, 250, 300, 350, 500, 550, 600. This embodiment of registering the tags 102 is described above with reference to FIG. 2A.

In another embodiment, registering the tag identifier of tag 102 with the location data 116 of the tag comprises initiating, by the application, a prior scan of the tag 102 to read the tag identifier from the tag 102, receiving, by an audio detection device 136 in the reader device 106, the audio signal 224 from the audio emitting device 143 of the tag 102, determining, by the application, the location data 116 of the tag 102 based on the audio attribute 119 of the audio signal 224, comparing, by the application, the audio attribute 119 of the audio signal 224 received from the tag 102 with a pre-stored audio attribute 119 of a plurality of audio signals 224 received from a plurality of different tags 102 stored at a data store 156 in the management system 150 to determine the tag identifier corresponding to the audio attribute 119 of the audio signal 224 received from the tag 102, and storing, by the application, the tag identifier with the location data 116 at the data store 110, 156. This embodiment of registering the tags 102 is described above with reference to FIG. 2B.

In an embodiment, initiating, by the application, the scan of the tag 102 comprises transmitting the signal to the tag 102, and receiving the tag data 112 from the tag 102, in which the tag data 112 comprises the tag identifier. In an embodiment, method 700 may further comprise determining, by the application, the location data 116 based on a signal strength of a signal carrying the tag data 112 received from the tag 102, and storing, by the application, the location data 116 based on the signal strength in the data store.

In an embodiment, method 700 may further comprise re-calibrating, by the application, the tag 102 by periodically receiving and storing updated audio attributes 119 of the audio signal 224 received from the tag 102, and receiving the tag data 112 from the tag 102. In an embodiment, method 700 may further comprise registering, by the application, a second tag identifier received from a second tag 102 in the inventory environment 103 with the location data 116 indicating the location of the tag 102 based on a rule 117. The rule 117 indicates that location data 116 for all tags 102 in an area 303A-B including the location of the tag 102 and a signal strength-based location (e.g., RSSI-based location data 116A) of the second tag 102 is to be set to the location data 116 of the tag 102. In an embodiment, the second audio attribute 119 is at least one of a volume, a pitch, a tone, or a duration of the audio signal 224.

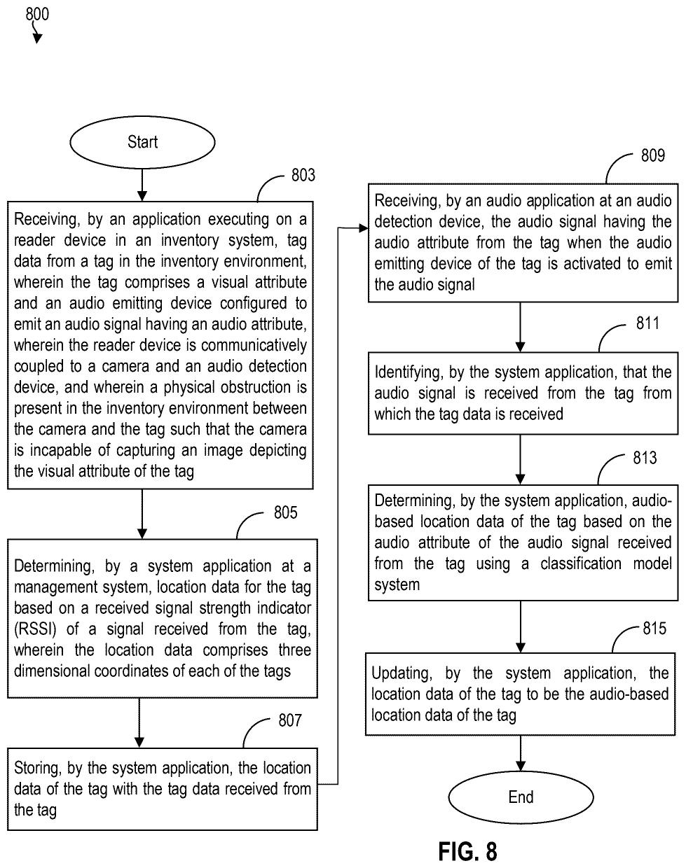

Turning now to FIG. 8, shown is a method 800 for managing locations of tags 102 in an inventory environment 103 according to various embodiments of the disclosure. Method 800 may be implemented by an inventory system (e.g., the inventory system 200, 250, 300, 350, 500, 550, 600). In embodiments, the method 800 may be implemented using a computer system with components as shown in FIG. 9. As illustrated, method 800 of FIG. 8 includes a number of enumerated operations, but embodiments of the operations in FIG. 8 may include additional operations before, after, and in between the enumerated operations. In some embodiments, one or more of the enumerated operations may be omitted or performed in a different order. Method 800 may be performed by an application executing at a computer system, and the application may refer to the camera application 133 at the camera 130, the audio application 139 at the audio detection device 136, the application 108 at the reader device 106, and/or the application 153 at the management system 150.

At step 803, method 800 comprises receiving, by an application executing on a computer system in an inventory system (e.g., the application 108 at the reader device 106), tag data 112 from a tag 102 in the inventory environment 103. In an embodiment, the tag 102 comprises a visual attribute 115 and an audio emitting device 143 configured to emit an audio signal 224 having an audio attribute 119. In an embodiment, the reader device 106 is communicatively coupled to a camera 130 and an audio detection device 136. In an embodiment, a physical obstruction 603 is present in the inventory environment 103 between the camera 130 and the tag 102 such that the camera 130 is incapable of capturing an image depicting the visual attribute 115 of the tag 102.

At step 805, method 800 comprises determining, by the application, location data 116 for the tag 102 based on a received signal strength indicator (RSSI) of a signal 555 received from the tag 102. The location data 116 comprises three dimensional (3D) coordinates of each of the tags 102. At step 807, method 800 comprises storing, by the application, the location data 116 of each of the tag 102 with the tag data 112 received from the tag 102.

At step 809, method 800 comprises receiving, by the application, the audio signal 224 having the audio attribute 119 from the tag 102 when the audio emitting device 143 of the tag 102 is activated to emit the audio signal 224.

At step 811, method 800 comprises identifying, by the application, that the audio signal 224 is received from the tag 102 from which the tag data 112 is received (e.g., the tag data 112 received at step 803). At step 813, method 800 comprises determining, by the application, audio-based location data 116B of the tag 102 based on the audio attribute 119 of the audio signal 224 received from the tag 102 using a classification model system 170. At step 815, method 800 comprises updating, by the application, the location data 116 of the tag 102 to be the audio-based location data of the tag 102.

Method 800 may further comprise additional attributes and/or steps not explicitly shown in FIG. 8. In an embodiment, the audio attribute 119 is at least one of a volume, a pitch, a tone, or a duration of the audio signal 224. In an embodiment, determining the location data 116 for the tag 102 based on the RSSI of one or more signals 555 received from the tag 102 comprises measuring, by the application, a strength of a signal 555 including the tag data 112 received from the tag, in which the RSSI is based on a distance between a tag 102 and the reader device 106, determining, by the application, the distance between the tag 102 and the reader device based on the RSSI, and determining, by the application, a location of the tag 102 based on the distance between the tag 102 and the reader device 106, in which the location data 116 for the tag 102 comprises the location of the tag 102. In an embodiment, the RSSI for the tag 102 may be converted to a distance between the tag 102 and the reader device 106 using predefined equations and models. The RSSI-based location detection may involve, for example, placing one or more reader devices 106 at known locations, measuring RSSI values from the signals received from the tags 102, converting the RSSI values to distances based on the known location of the readers, and in some cases, applying trilateration with other known data to estimate the coordinates of a tag 102.

In an embodiment, the audio detection device 136 is a microphone configured to detect the audio signal 224 from the tag 102 when the audio detection device 136 is within an audio zone of the tag 102. In an embodiment, the visual attribute 115 of the first tag 102 comprises at least one of an arrangement of the one or more LEDs 122 to create a pattern, a color of the one or more LEDs 122 when lit, a brightness of the one or more LEDs 122 when lit, a background color of the first tag 102, or the one or more QR codes 121 printed on the first tag 102.

FIG. 9 illustrates a computer system 900 suitable for implementing one or more embodiments disclosed herein. In an embodiment, cameras 130, audio detection devices 136, computer system 140, audio emitting devices 143, reader devices 106, and/or management system 150, etc., may each be implemented as the computer system 900. The computer system 900 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 900, at least one of the CPU 382, the RAM 388, and the ROM 386 are changed, transforming the computer system 900 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 900 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 900 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 900 to provide the functionality of a number of servers that is not directly bound to the number of computers in the computer system 900. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 900, at least portions of the contents of the computer program product to the secondary storage 384, to the ROM 386, to the RAM 388, and/or to other non-volatile memory and volatile memory of the computer system 900. The processor 382 may process the executable instructions and/or data structures in part by directly accessing the computer program product, for example by reading from a CD-ROM disk inserted into a disk drive peripheral of the computer system 900. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 900.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 900 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for determining and managing locations of a plurality of tags in an inventory environment in which a physical obstruction is present in the inventory environment between a camera and a tag, wherein the method comprising:
receiving, by an application executing at a reader device in an inventory system, tag data from the tag in the inventory environment, wherein the tag comprises a visual attribute and an audio emitting device configured to emit an audio signal having an audio attribute, wherein the reader device is communicatively coupled to the camera and an audio detection device, and wherein the camera is incapable of capturing an image depicting the visual attribute of the tag due to the physical obstruction;
determining, by a system application executing at a management system in the inventory system, location data for the tag based on a received signal strength indicator (RSSI) of a signal received from the tag, wherein the location data comprises three dimensional coordinates of each of the tags;
storing, by the system application, the location data of the tag with the tag data received from the tag;
receiving, by an audio application of an audio detection device in the inventory system, the audio signal having the audio attribute from the tag when the audio emitting device of the tag is activated to emit the audio signal;
identifying, by the system application, that the audio signal is received from the tag from which the tag data is received;
determining, by the system application, audio-based location data of the tag based on the audio attribute of the audio signal received from the tag using a classification model system; and
updating, by the system application, the location data of the tag to be the audio-based location data of the tag.

2. The method of claim 1, wherein the audio attribute is at least one of a volume, a pitch, a tone, or a duration of the audio signal.

3. The method of claim 1, wherein determining the location data for the tag based on the RSSI of one or more signals received from the tag comprises:
measuring, by the system application, a strength of a signal including the tag data received from the tag, wherein the RSSI is based on a distance between a tag and a reader device;
determining, by the system application, the distance between the tag and the reader device based on the RSSI; and
determining, by the system application, a location of the tag based on the distance between the tag and the reader device, wherein the location data for the tag comprises the location of the tag.

4. The method of claim 1, wherein the audio detection device is a microphone configured to detect the audio signal from the tag when the audio detection device is within an audio zone of the tag.

5. The method of claim 1, wherein the visual attribute of the tag comprises at least one of an arrangement of one or more LEDs to create a pattern, a color of the one or more LEDs when lit, a brightness of the one or more LEDs when lit, a background color of the first tag, or one or more QR codes printed on the first tag.

6. An inventory system, comprising:
one or more tags positioned in an inventory environment;
a reader device comprising a first processor configured to execute a reader application to:
initiate a scan of each the one or more tags; and
receive tag data from each of the one or more tags;
an audio detection device positioned within an audio zone of the one or more tags and comprising a second processor configured to execute an audio application to:
receive an audio signal from an audio emitting device of the one or more tags;
obtain audio data associated with the audio signal and indicating an audio attribute of the audio signal; and
determine, using a classification model system, location data for each of the one or more tags using the audio attribute of the audio signal received from each of the one or more tags based on a predefined schedule for individually scanning the one or more tags and pre-stored audio attributes of the one or more tags; and
a data store configured to register locations of each of the one or more tags by storing the location data for each the one or more tags with the tag data received from each of the one or more tags based on the predefined schedule or the pre-stored audio attributes of the one or more tags.

7. The inventory system of claim 6, wherein when the locations of each of the one or more tags are registered based on the predefined schedule for individually scanning the one or more tags, the reader application and the audio application are configured to individually scan each of the one or more tags and receive the audio signal from each of the one or more tags according time intervals indicated in the predefined schedule, and the data store is configured to individually register the location data of the each of the one or more tags with the tag data received from each of the one or more tags individually.

8. The inventory system of claim 7, wherein the predefined schedule indicates a frequency at which the reader device and the audio detection device are to communicate with different tags of the one or more tags.

9. The inventory system of claim 6, wherein when the locations of each of the one or more tags are registered based the pre-stored audio attributes associated with the one or more tags, the data store is configured to store the pre-stored audio attributes of each of one or more tags in association with a tag identifier prior to the one or more tags entering the inventory environment.

10. The inventory system of claim 9, wherein the inventory system further comprises an application executing on a third processor and configured to compare the audio attribute of the audio signal with the pre-stored audio attributes of each of the one or more tags to identify the tag identifier for each of the one or more tags from which the audio signal is received, and wherein the data store is configured to register the locations of the each of the one or more tags based on the comparison.

11. The inventory system of claim 9, wherein the audio attribute is at least one of a volume, a pitch, a tone, or a duration of the audio signal.

12. The inventory system of claim 6, wherein the location data of each of the one or more tags is determined based on audio signals received from three different audio emitting devices.

13. A method, comprising:
registering, by an application executing at a computer system in an inventory system, a tag identifier received from a tag in an inventory environment with location data indicating a location of the tag based on an audio attribute of an audio signal received from the tag;
initiating, by the application, a scan of the tag to obtain tag data from the tag and to receive the audio signals from the tag by transmitting a signal to the tag after registering the tag identifier with the location data of the tag; and
triggering, by the application, activation of an audio emitting device of the tag to emit an alert signal indicating whether a reader device is in a read range of the tag, wherein a second audio attribute of the alert signal indicates whether the reader device is in the read range of the tag, and wherein the signal is used to activate the audio emitting device of the tag.

14. The method of claim 13, wherein registering, by the application, the tag identifier of the tag with the location data indicating the location of the tag comprises:
initiating, by the application, a prior scan of the tag at a first time according to a predefined schedule to read the tag identifier from the tag;
receiving, by an audio detection device in the reader device, the audio signal from the audio emitting device of the tag at the first time according to the predefined schedule;
determining, by the application using a classification model system, the location data of the tag based on the audio attribute of the audio signal; and
storing, by the application, the tag identifier with the location data at a data store in the inventory system.

15. The method of claim 13, wherein registering, by the application, the tag identifier of the tag with the location data indicating the location of the tag comprises:
initiating, by the application, a prior scan of the tag to read the tag identifier from the tag;
receiving, by an audio detection device in the reader device, the audio signal from the audio emitting device of the tag;
determining, by the application, the location data of the tag based on the audio attribute of the audio signal;
comparing, by the application, the audio attribute of the audio signal received from the tag with a pre-stored audio attribute of a plurality of audio signals received from a plurality of different tags stored at a data store in the inventory system to determine the tag identifier corresponding to the audio attribute of the audio signal received from the tag; and
storing, by the application, the tag identifier with the location data at the data store.

16. The method of claim 13, wherein initiating, by the application, the scan of the tag comprises:
transmitting, by the application, the signal to the tag; and
receiving, by the application, the tag data from the tag, wherein the tag data comprises the tag identifier.

17. The method of claim 13, further comprising:
determining, by the application, the location data based on a signal strength of a signal carrying the tag data received from the tag; and
storing, by the application, the location data based on the signal strength in a data store in the inventory system.

18. The method of claim 13, further comprising re-calibrating, by the application, the tag by periodically receiving and storing, by the application, updated audio attributes of the audio signal received from the tag, and receiving, by the application, the tag data from the tag.

19. The method of claim 13, further comprising registering, by the application, a second tag identifier received from a second tag in the inventory environment with the location data indicating the location of the tag based on a rule, wherein the rule indicates that location data for all tags in an area including the location of the tag and a signal strength-based location of the second tag is to be set to the location data of the tag.

20. The method of claim 13, wherein the second audio attribute is at least one of a volume, a pitch, a tone, or a duration of the audio signal.
